(19) United States
(12) Patent Application Publication
(10) Pub. No.: US 2026/0356075 A1
(43) Pub. Date: Nov. 12, 2026

(54) Air Permeable Nonwoven Composite

(71) Applicant: Kimberly-Clark Worldwide, Inc., Neenah, WI (US)

(72) Inventors: Shawn E. Jenkins, Suwanee, GA (US); Howard M. Welch, Woodstock, GA (US); Renee L. Johns, Johns Creek, GA (US); David J. Reader, Appleton, WI (US); Doug Gorman, Cumming, GA (US); Glynis A. Walton, Roswell, GA (US); Christopher M. Allen, Smyrna, GA (US); Terrance G. Vosters, Appleton, WI (US)

(21) Appl. No.: 19/135,431

(22) PCT Filed: Dec. 8, 2023
(86) PCT No.: PCT/US2023/083101

§ 371 Date: Jun. 4, 2025

Related U.S. Application Data
(60) Provisional application No. 63/431,418, filed on Dec. 9, 2022.

(51) Int. Cl. B32B 5/02; B32B 27/12; B32B 27/32; B32B 37/00; B32B 37/04; B32B 38/00; B32B 38/04

(52) U.S. Cl. CPC B32B 5/022; B32B 27/12; B32B 27/32; B32B 37/0053; B32B 37/04; B32B 38/04; B32B 38/1875; B32B 2038/047; B32B 2250/04; B32B 2262/0253; B32B 2307/724; B32B 2323/04; B32B 2323/10; B32B 2555/02

(57) ABSTRACT

An air permeable, elastic nonwoven composite that contains an elastic film laminated to one or more nonwoven web materials is described. The elastic film is fed into a bonding and perforating device while the film is stretched to form the laminate. The laminate is then maintained in a stretched state after exiting the bonding and perforating device for better control over the permeability properties.

### BACKGROUND

Elastic materials are commonly incorporated into clothing and personal care articles worn on or about the body in order to improve fit and the ability of the article to conform to the contours of a moving body. Examples of such articles include diapers, training pants, adult incontinence garments, personal protective garments, bandages, and so forth. However, elastic materials often present an undesirable hand-feel such as having a tacky or rubbery feel. Thus, in clothing and personal care articles, it is common to employ elastic materials between one or more outer facing materials that present a pleasing hand. For example, in personal care articles it is common to have one or more nonwoven fabrics with the desired hand-feel laminated to the elastic material as an outer facing so that the elastic laminate is more pleasing to the touch. In one practice, the nonwoven fabric is joined to an elastic film while the film is in a stretched condition so that, upon retraction of the elastic film, the nonwoven fabric bunches and forms gathers between the locations where it is bonded to the elastic film. The resulting elastic laminate is stretchable at least to the extent that the nonwoven fabric can extend by flattening out the gathers located between the bond sites. Examples of such stretch bonded elastic laminates are disclosed in numerous references including, for example, in U.S. Pat. No. 4,720,415 to Vander Wielen et al. and U.S. Pat. No. 5,385,775 to Wright et al.

In order to support skin wellness, there is also a desire that such elastic laminates allow water vapor, trapped between the skin of the wearer and the laminate, to escape. These are commonly referred to as ‘breathable’ materials. Most elastomeric polymer films have very low water vapor transmission rates and would not be considered to be breathable. Thus, it has become common to perforate such elastic laminates in order to allow water vapor trapped against the skin to escape. Examples of such apertured elastic laminates include those described in U.S. Pat. No. 7,803,244 Siqueira et al., U.S. Pat. No. 8,241,542 O'Donnell et al., U.S. Pat. No. 8,292,865 to Hutson et al. and EP1397101B1 Curro et al., which are incorporated herein by reference.

In one process, an apertured composite is formed by passing an elastic film through a nip to bond the film to a nonwoven web material. Concurrent with bond formation, apertures are also formed into the elastic film. The apertures are of a size sufficient to provide a desired level of texture, softness, hand feel, and/or aesthetic appeal to the composite without having a significant adverse effect on the elastic properties. Such processes are disclosed, for instance, in U.S. Pat. Nos. 9,011,625 and 11,220,085, which are both incorporated herein by reference. The products made from the above processes have provided great advancements in the art. In some instances, however, desired air permeability levels are not obtained or eroded after the elastic composite is formed. Thus, a need remains for a process capable of producing elastic composites that provides better control over the air permeability properties of the composite as it is formed.

### SUMMARY

The present disclosure is generally directed to a process of simultaneously melt fusing and perforating film-based elastic laminates in a manner that better controls the resulting permeability properties of the laminate. Through the process of the present disclosure, air permeable elastic laminates can be formed that include facing layers that, in the past, had a tendency to interfere with the permeability properties of the laminate after perforating. For example, in the past, it was difficult to control the air permeability properties of laminates in which the laminates contained nonwoven webs having a high density of fibers and/or very fine fibers. Problems were also experienced in the past in controlling the permeability properties of laminates that contained facing layers containing relatively low melting point polymers. The process of the present disclosure, however, provides better control over the permeability properties and results in the production of elastic laminates with unique properties including increased permeability.

In one aspect, for instance, the present disclosure is directed to a process of forming a nonwoven composite. The method includes feeding an elastic film and a nonwoven web material through a bonding and perforating device for concurrently bonding or melt fusing the film to the nonwoven web material and forming apertures in the film while the film is under tension at a stretch ratio of about 1.5 or more in the machine direction, such as at a stretch ratio of from about 2.5 to about 12. In accordance with the present disclosure, the film is maintained under tension such that the film retracts by no more than about 60%, such as by no more than about 50%, such as by no more than about 30%, such as by no more than about 20%, such as by no more than about 10% in the machine direction after the apertures have formed and the film has been melt fused to the nonwoven web material. Thereafter, the nonwoven composite can be completely retracted or retracted such that less than 20% of stretch remains in the film in the machine direction prior to or during winding into a roll. During the process, at least one of the apertures formed into the elastic film has a length of from about 200 micrometers to about 5,000 micrometers. The resulting nonwoven composite can have a permeability of greater than about 10 CFM, such as greater than about 25 CFM, such as greater than about 30 CFM, such as greater than about 50 CFM, such as greater than about 80 CFM.

According to the process of the present disclosure, the film can be maintained under tension after the apertures have formed and the film has been melt fused to the nonwoven web material for at least about 0.1 seconds, such as at least about 0.2 seconds, such as at least about 0.3 seconds, and for less than about 10 seconds. The film can be maintained under tension after the apertures have formed and the film has been melt fused to the nonwoven web material by a downstream tension device. The downstream tension device can comprise a nip formed between two rolls or can comprise an S-wrap configuration of guide rolls.

In one aspect, the bonding and perforating device can comprise intermeshing grooved rolls that cause the nonwoven web and elastic film to become melt fused and cause controlled rupturing of the film. Alternatively, the bonding and perforating device can comprise a nip formed between at least one patterned roll that causes point bonding and melt fusing to occur. Although the elastic film is apertured during the process, in one aspect, the nonwoven web material is unapertured after being melt fused to the film. In one aspect, an additional nonwoven web material can be passed through the bonding and perforating device so that the elastic film is positioned between the two nonwoven web materials to form the laminate.

Through the process of the present disclosure, various unique nonwoven composite materials can be formed. For instance, facing materials can be incorporated into the nonwoven composite that contain low temperature polymers and/or contain densely packed and/or very fine fibers while still producing a composite with desired permeability properties.

In one aspect, the nonwoven composite can include an elastic film that contains an elastomeric polymer. The elastic film can be positioned adjacent and melt fused to a nonwoven web material so that the elastic film adheres to the nonwoven web material at a plurality of discrete bond sites. The elastic film can define a plurality of apertures having a perimeter about which the corresponding discrete bond sites are proximately located. At least one of the apertures can have a length of from about 200 to about 5,000 micrometers. In accordance with the present disclosure, the nonwoven web material contains fibers that comprise a low temperature polymer. The nonwoven material can be unapertured at an area adjacent to the apertures in the film and can be unbonded to the film except at the corresponding discrete bond sites. In accordance with the present disclosure, the resulting nonwoven composite can have a permeability of greater than about 10 CFM, such as greater than about 25 CFM, such as greater than about 30 CFM, such as greater than about 50 CFM, such as greater than about 70 CFM, such as greater than about 90 CFM, such as greater than about 120 CFM.

The fibers contained in the nonwoven web material can be spunbond fibers, meltblown fibers, staple fibers, or combinations thereof. The low temperature polymer can have a melting point of less than about 150 °C, such as less than about 140 °C, such as less than about 130 °C, such as less than about 120 °C, such as less than about 110 °C, such as less than about 100 °C. The melting temperature can be determined using DSC, such as by using ASTM Test D3418-21. The low temperature polymer, in one aspect, can comprise a polyethylene polymer, a poly(lactic acid) polymer, a polyhydroxyalkanoate polymer, a poly(ethylene adipate) polymer, a poly(ethylene oxide) (PEG) polymer, a plastomer, a random copolymer, or a polymer blend containing a plasticizer. In another embodiment, the low temperature polymer can comprise an elastomer, such as a polyolefin elastomer.

In still another embodiment, the present disclosure is directed to a nonwoven composite that includes an elastic film that contains an elastomeric polymer and at least one skin layer. The skin layer can comprise a low temperature polymer as described above. The elastic film can be positioned adjacent and melt fused to a nonwoven web material containing fibers along a surface of the film opposite the skin layer so that the elastic film adheres to the nonwoven web material at a plurality of discrete bond sites. The elastic film can define a plurality of apertures having a perimeter about which the corresponding discrete bond sites are proximately located. At least one of the apertures can have a length of from about 200 to about 5,000 micrometers. The nonwoven web material, on the other hand, can be unapertured at an area adjacent to the apertures in the film and can be unbonded to the film except at the corresponding discrete bond sites. The nonwoven composite can have a permeability of greater than about 10 CFM, such as greater than about 25 CFM, such as greater than about 30 CFM, such as greater than about 50 CFM, such as greater than about 70 CFM, such as greater than about 90 CFM.

The breathable and elastic nonwoven composites of the present disclosure can be used in numerous and diverse applications. In one embodiment, for instance, the material can be incorporated into an absorbent article.

Other features and aspects of the present disclosure are discussed in greater detail below.

### BRIEF DESCRIPTION OF THE DRAWINGS

A full and enabling disclosure of the present disclosure is set forth more particularly in the remainder of the specification, including reference to the accompanying figures, in which:

FIG. 1 is a schematic illustration of one embodiment of a method for forming an elastic laminate in accordance with the present disclosure;

FIG. 2 is another embodiment of a schematic illustration of a method for forming an elastic laminate in accordance with the present disclosure;

FIG. 3 is another embodiment of a schematic illustration of a method for forming an elastic laminate in accordance with the present disclosure;

FIG. 4 is a cross-sectional view of one embodiment of an elastic film containing a skin layer that may be used to produce elastic laminates in accordance with the present disclosure; and

FIG. 5 is a perspective view of one embodiment of an absorbent article incorporating composite elastic laminates made in accordance with the present disclosure.

Repeat use of reference characters in the present specification and drawings is intended to represent the same or analogous features or elements of the present invention.

### DEFINITIONS

Throughout the specification and claims, discussion of the articles and/or individual components thereof is with the understanding set forth below.

The term “comprising” or “including” or “having” are inclusive or open-ended and do not exclude additional unrecited elements, compositional components, or method steps. Accordingly, the terms “comprising” or “including” or “having” encompass the more restrictive terms “consisting essentially of” and “consisting of.”

As used herein the term “aperture” means a continuous uninterrupted hole or opening that extends through the entire thickness of a layer, or where the context so implies, through the thickness of the entire laminate.

As used herein, the term “polymer” generally includes but is not limited to, homopolymers, copolymers, such as for example, block, graft, random and alternating copolymers, terpolymers, etc. and blends and modifications thereof. Furthermore, unless otherwise specifically limited, the term “polymer” shall include all possible geometrical configurations of the molecule. These configurations include, but are not limited to isotactic, syndiotactic and random symmetries.

As used herein “propylene polymer” means a polymer having greater than 50% propylene content (mole percent).

As used herein “ethylene polymer” means a polymer having greater than 50% ethylene content (mole percent).

As used herein “olefin polymer” means a polymer having greater than 50% olefin content (mole percent).

As used herein, the term “fabric” means a cohesive fibrous sheet-like material including woven, knitted, and nonwoven materials.

As used herein, the term “nonwoven web” means a structure or a web of material that has been formed without use of traditional fabric forming processes such as weaving or knitting, to produce a structure of individual fibers or threads that are entangled or intermeshed, but not in an identifiable, repeating manner.

As used herein “spunbond” fibers and “spunbond” nonwoven webs comprise continuous fiber webs formed by extruding a molten thermoplastic material from a plurality of fine capillaries as molten threads into converging high velocity hot air streams which attenuate the filaments of molten thermoplastic material to reduce their diameter. The educative drawing of the spunbond process also acts to impart a degree of crystallinity to the formed polymeric fibers which provides a web with relatively increased strength. By way of non-limiting example, spunbond fiber nonwoven webs and processes for making the same are disclosed in U.S. Pat. No. 4,340,563 to Appel et al, U.S. Pat. No. 5,382,400 to Pike et al.; U.S. Pat. No. 8,246,898 to Conrad et al., U.S. Pat. No. 8,333,918 to Lennon et al. and so forth.

As used herein “meltblown” fibers and “meltblown” nonwoven webs generally refer to those formed by a process in which a molten thermoplastic material is extruded through a plurality of fine, usually circular, die capillaries as molten fibers into converging high velocity gas (e.g. air) streams that attenuate the fibers of molten thermoplastic material to reduce their diameter. Thereafter, the meltblown fibers are carried by the high velocity gas stream and are deposited on a collecting surface to form a web of randomly dispersed meltblown fibers. By way of non-limiting example, meltblown fiber nonwoven webs and processes for making the same are disclosed in U.S. Pat. No. 3,849,241 to Butin, et al.; U.S. Pat. No. 4,775,582 to Abba et al., U.S. Pat. No. 4,707,398 to Wisneski et al.; U.S. Pat. No. 5,652,048 to Haynes et al, U.S. Pat. No. 6,972,104 to Haynes et al. and so forth.

As used herein, the term “machine direction” or “MD” refers to the direction of travel of the film in the method of manufacture.

As used herein, the term “cross-machine direction” or “CD” refers to the direction which is essentially perpendicular to the machine direction defined above.

As used herein, the term “elastomeric” and “elastic” refer to a material that, upon application of a stretching force, is stretchable in at least one direction (such as the MD direction), and which upon release of the stretching force, contracts/returns to approximately its original dimension. For example, a stretched material may have a stretched length that is at least 50 percent greater than its relaxed unstretched length, and which will recover at least 50 percent of its stretched dimension (i.e. the stretched length minus the original, relaxed length length) upon release of the stretching force. A hypothetical example would be a one (1) inch sample of a material that is stretchable to at least 1.50 inches and which, upon release of the stretching force, will recover to a length not less than 1.25 inches. Desirably, the material contracts or recovers greater than 60%, 65%, 70%, 75% and even more desirably, greater than 80 percent of the stretched length.

As used herein “personal care articles” or “absorbent articles” means any and all articles or products used for personal health or hygiene including diapers, adult incontinence garments, absorbent pants and garments, tampons, feminine pads and liners, bodily wipes (e.g. baby wipes, perineal wipes, hand wipes, etc.), bibs, changing pads, bandages, and components thereof.

As used herein “protection articles” means all articles intended to protect a user or equipment from contact with or exposure to external matter including, for example, face masks, protective gowns and aprons, gloves, caps, shoe covers, equipment covers, sterile wrap (e.g. for medical instruments), car covers, and so forth.

As used herein, the term “thermal point bonding” generally refers to a process performed, for example, by passing a material between a patterned roll (e.g., calender roll) and another roll (e.g., anvil roll), which may or may not be patterned. One or both of the rolls are typically heated.

As used herein, a “low temperature polymer” refers to a polymer having a melting point of less than 150 °C unless otherwise indicated or has a VICAT softening temperature of less than about 125 °C unless otherwise indicated. The low temperature polymer can have a melting point of less than about 140 °C, such as less than about 130 °C, such as less than about 125 °C, such as less than about 120 °C, such as less than about 115 °C, such as less than about 110 °C, such as less than about 105 °C, such as less than about 100 °C, such as less than about 95 °C, such as less than about 90 °C. The low temperature polymer can have a VICAT softening temperature of less than about 120 °C, such as less than about 110 °C, such as less than about 100 °C, such as less than about 90 °C, such as less than about 80 °C, such as less than about 70 °C, such as less than about 60 °C, such as less than about 50 °C, and greater than about 40 °C. Optionally, the low temperature polymer can have a Shore A Hardness of less than about 125, such as less than about 110, such as less than about 100, such as less than about 95, such as less than about 90, and greater than about 50, such as greater than about 65.

As used herein, the melting point, glass transition temperature, and percent crystallinity of a polymer can be determined by differential scanning calorimetry (DSC). The differential scanning calorimeter is a THERMAL ANALYST 2910 Differential Scanning calorimeter, which is outfitted with a liquid nitrogen cooling accessory and with a THERMAL ANALYST 2200 (version 8.10) analysis software program, both of which are available from T.A. Instruments Inc. of New Castle, Del. To avoid directly handling the samples, tweezers or other tools are used. The samples are placed into an aluminum pan and weighed to an accuracy of 0.01 milligram on an analytical balance. A lid is crimped over the material sample onto the pan. Typically, the resin pellets are placed directly in the weighing pan, and the fibers are cut to accommodate placement on the weighing pan and covering by the lid. The differential scanning calorimeter is calibrated using an indium metal standard and a baseline correction is performed, as described in the operating manual for the differential scanning calorimeter. A material sample is placed into the test chamber of the differential scanning calorimeter for testing, and an empty pan is used as a reference. All testing is run with a 55-cubic centimeter per minute nitrogen (industrial grade) purge on the test chamber. For resin pellet samples, the heating and cooling program is a 2-cycle test that began with an equilibration of the chamber to −25 °C, followed by a first heating period at a heating rate of 10 °C per minute to a temperature of 200 °C, followed by equilibration of the sample at 200 °C for 3 minutes, followed by a first cooling period at a cooling rate of 20 °C per minute to a temperature of −25 °C, followed by equilibration of the sample at −25 °C for 3 minutes, and then a second heating period at a heating rate of 10 °C per minute to a temperature of 200 °C. For fiber samples, the heating and cooling program is a 1-cycle test that begins with an equilibration of the chamber to −25 °C, followed by a heating period at a heating rate of 20 °C per minute to a temperature of 200 °C, followed by equilibration of the sample at 200 °C for 3 minutes, and then a cooling period at a cooling rate of 10 °C per minute to a temperature of −25 °C. All testing is run with a 55-cubic centimeter per minute nitrogen (industrial grade) purge on the test chamber. The results are then evaluated using the THERMAL ANALYST 2200 analysis software program, which identifies and quantifies the glass transition temperature (Tg) of inflection, the endothermic and exothermic peaks, and the areas under the peaks on the DSC plots. The glass transition temperature is identified as the region on the plot-line where a distinct change in slope occurred, and the melting temperature is determined using an automatic inflection calculation. The areas under the peaks on the DSC plots are determined in terms of joules per gram of sample (J/g). For example, the endothermic heat of melting of a resin or fiber sample is determined by integrating the area of the endothermic peak. The area values are determined by converting the areas under the DSC plots (e.g. the area of the endotherm) into the units of joules per gram (J/g) using computer software. The % crystallinity is calculated as follows:

% crystallinity=100*(A−B)/C

wherein,
A is the sum of endothermic peak areas (J/g);
B is the sum of exothermic peak areas (J/g); and
C is the endothermic heat of melting value for the selected polymer where such polymer has 100% crystallinity (J/g). For polylactic acid, C is 93.7 J/g (Cooper-White, J. J., and Mackay, M. E., Journal of Polymer Science, Polymer Physics Edition, p. 1806, Vol. 37, (1999). The areas under any exothermic peaks encountered in the DSC scan due to insufficient crystallinity are subtracted from the area under the endothermic peak to appropriately represent the degree of crystallinity.

As used herein, the term “biodegradable” or “biodegradable polymer” generally refers to a material that degrades from the action of naturally occurring microorganisms, such as bacteria, fungi, and algae; environmental heat; moisture; or other environmental factors. The biodegradability of a material may be determined using ASTM Test Method 5338.92.

As used herein, a “bio-based polymer” refers to a polymer produced from sustainable resources such as plant and animal materials. In one aspect, the bio-based polymer can be produced from biomass.

### DETAILED DESCRIPTION

It is to be understood by one of ordinary skill in the art that the present discussion is a description of exemplary embodiments only and is not intended as limiting the broader aspects of the present disclosure.

In general, the present disclosure is directed to a method of forming nonwoven composites. The nonwoven composites contain at least one elastic film layer that is bonded to at least one nonwoven material layer. During the method of making the nonwoven composite, the elastic film layer is stretched, apertured, and bonded to the nonwoven material layer. In accordance with the present disclosure, the film is maintained under tension for a period of time after the apertures have formed and the film has been bonded to the nonwoven material. It was discovered that maintaining the film in a stretched state after being apertured can unexpectedly and dramatically improve and control the air permeable properties of the nonwoven composite. For example, through the process of the present disclosure, the air permeability of the nonwoven composite can be much greater than what would otherwise occur if the elastic film were able to retract after the apertures were formed.

By being able to control the air permeability properties of the elastic nonwoven composites, unique and novel air permeable laminates can be produced. For example, in the past, incorporating low temperature polymers into one or more layers of the nonwoven composite, incorporating very fine fibers into the nonwoven web material layer, and/or using a nonwoven web material having an increased density of fibers had a tendency to degrade or otherwise interfere with the air permeability properties of the elastic composite as it was being apertured. Through the process of the present disclosure, however, low temperature polymers can be incorporated into the elastic film layer or the one or more nonwoven layers while still producing a nonwoven composite with significant air permeability properties. Similarly, nonwoven composites can be produced according to the present disclosure having desired air permeability levels while still containing a nonwoven web material containing fine fibers and/or a high density of fibers.

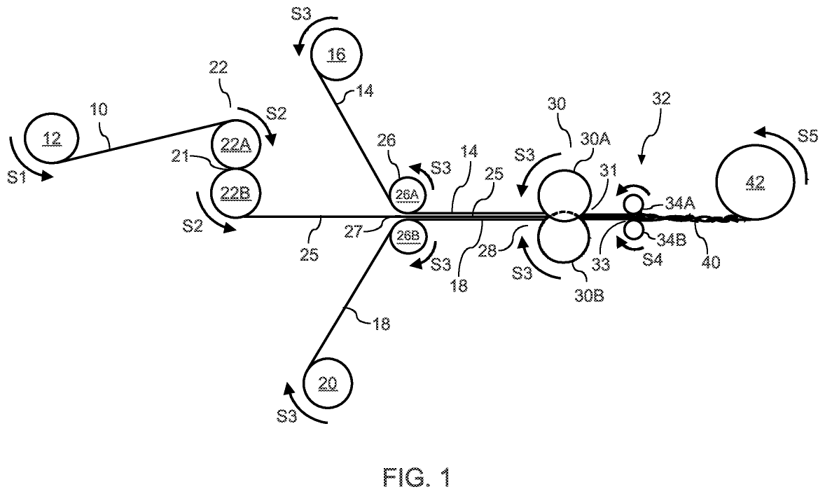

Referring to FIG. 1, one embodiment of a process in accordance with the present disclosure for forming elastic nonwoven composites is shown. In this embodiment, an elastic film is stretched and bonded on each side to a nonwoven web material. In other embodiments as will be explained below, the elastic film can be bonded to a single nonwoven web material on one side. In still other embodiments, multiple layers of nonwoven web materials can be attached and bonded to the elastic film during the process.

Referring to FIG. 1, an elastomeric film 10 is provided and unwound from a first supply roll 12. The elastomeric film 10 can be made in various different ways. For instance, the elastomeric film 10 can be produced using blowing, casting, extruding, or the like. In one aspect, molten elastomer is extruded, thinned, and chilled to form a film. After chilling the film, the film may be drawn by stretching and reduced in thickness. The elastic film 10 can be stretched uniaxially or biaxially in the machine direction, the cross-machine direction, or both. In one aspect, the elastic film 10 may be clamped at its lateral edges by chain clips and conveyed into a tenter frame. In the tenter frame, the film may be drawn in the cross-machine direction to the desired draw ratio. While being drawn in the cross-machine direction, the elastic film 10 may also be stretched in the machine direction utilizing an S-wrap system as shown in FIG. 1 or using other devices. In the embodiment illustrated in FIG. 1, the elastomeric film 10 was previously formed and is being unwound from a first supply roll 12.

The elastomeric film 10 travels away from the first supply roll 12 and towards a first roller assembly 22 that includes first roll 22A and second roll 22B. The pair of rolls 22A and 22B are positioned proximate one another so as to form a nip 21 and rotate in opposite directions as indicated by the corresponding arrows. The circumferential speed (S2) of the first roller assembly 22 and corresponding drive rolls 22A, 22B is approximately the same as the speed (S1) of the unwind roll 12; the speeds may vary slightly as desired to maintain a small degree of tension or slack on the film to facilitate handling. The elastomeric polymer film 10 passes through the nip 21 of the first roller assembly 22 and travels in the direction towards and enters a nip 27 of a second roller assembly 26 comprising a pair of drive rollers 26A, 26B.

The circumferential speed (S3) of the second roller assembly 26 and corresponding drive rolls 26A, 26B is higher than the circumferential speed (S2) of the first roller assembly 22 and its drive rollers 22A, 22B. Thus, as it travels between the first and second roller assemblies 22, 26 the elastomeric film 25 is elongated or stretched in the MD. In certain embodiments, the peripheral speed of the downstream roller assembly (S3) can be at least 150%, 250%, 300% or 400% higher than the peripheral speed of the upstream roller assembly (S2). In still further embodiments, the peripheral speed of the downstream roller assembly, e.g. assembly 26, can be between about 200 and about 1200%, between about 250% and about 1000% or even between about 300% and about 900% of the peripheral speed of the upstream roller assembly.

It will be appreciated that the degree of stretching of the elastic film may be achieved in a single stretching operation or in a plurality of discrete stretching operations. For example, in an alternate embodiment, the speed (S1) of the supply roll 12 could optionally be slower than the speed (S2) of the first roller assembly 22 thereby having a first stretching operation stretching elastic film 10 between roller assemblies 12 and 22 and a second stretching operation stretching elastic film 25 between roller assemblies 22 and 26. The number and degree of individual stretching operations can vary to achieve the desired degree of overall stretch. In this regard, prior to entering the nip of the bonding and perforating device, the elastic film can be elongated or stretched in the machine direction at a stretch ratio of from about 1.5 to about 12, including all increments of 0.1 therebetween. For example, the stretch ratio can be greater than about 2, such as greater than about 2.5, such as greater than about 3, such as greater than about 3.5, such as greater than about 4, such as greater than about 4.5. The stretch ratio is generally less than about 10, such as less than about 8, such as less than about 7.5, such as less than about 7, such as less than about 6.5.

In addition to the elastomeric film, at least one support material, such as a fabric, is employed as a facing material for laminating to the elastomeric film. In this regard, the fabric may comprise one or more fibrous materials having desired physical attributes, such as pleasing hand, softness, improved aesthetics, tensile strength and so forth. The fabrics may be made in-line with the elastomeric polymer film and/or provided from a supply roll. In reference to FIG. 1, a first fabric 14 may be unwound from a second supply roll 16 and directed towards the nip 27 of the second roller assembly 26. The first fabric 14 is superimposed with the stretched elastomeric polymer film 25 prior to or immediately upon entering the nip 27. Often it will be desirable for the laminate to have an outer facing on both sides of the elastic and resulting composite elastic laminate. Thus, a second fabric 18 may simultaneously be unwound from a third supply roll 20 and likewise directed towards the nip 27 of the second roller assembly 26. However, while the second fabric 18 is also superimposed with the stretched elastomeric film prior to or immediately upon entering the nip 27, it is positioned against the underlying or opposite side of the elastomeric film 25 such that the elastomeric film 25 is positioned between the opposed outer fabrics 14, 18. The multiple superposed layers 14, 25, 18 together form a sheet stack. Unlike the elastomeric film 10, the nonwoven webs 14, 18 are not significantly stretched as they travel between their respective supply rolls 16, 20 and the bonding and perforating device 30. In this regard, the circumferential speed (S3) of the supply rolls 16, 20 is substantially similar to that of the second roller assembly 26 and bonding and perforating device 30.

The sheet stack is directed into the bonding and perforating device 30 for concurrently melt fusing the film 25 to the nonwoven web materials 14 and 18 and forming apertures in the film 25 while the film 25 is under tension in a stretched state. The bonding and perforating device 30 can comprise any suitable device capable of melt fusing the film to the nonwoven web materials and forming apertures. In the embodiment illustrated in FIG. 1, for instance, the bonding and perforating device/roll assembly 30 defines a nip 31 formed between two opposing rolls 30A and 30B. In one aspect, lamination is accomplished via a patterned bonding technique in which the stack is supplied to the nip 31 defined by at least one patterned roll. Thermal point bonding, for instance, typically employs a nip formed between two rolls (e.g., 30A, 30B) at least one of which is patterned (e.g., 30A). The patterned roll can contain a plurality of raised bonding elements to concurrently bond the film to the nonwoven web materials and form apertures in the film. The size of the bonding elements may be specifically tailored to facilitate the formation of apertures in the film and enhance melt fusing between the film and the nonwoven web materials. For example, the bonding elements can have a relatively large length dimension such as from about 300 microns to about 5,000 microns. The width dimension, on the other hand, of the bonding elements can be from about 20 microns to about 500 microns. In addition to the size of the bonding elements, the overall bonding pattern may be selectively controlled to achieve desired aperture formation. Alternatively, the bonding and perforating device can comprise a grooved roll assembly 30 having first and second inter-meshing grooved rolls 30A, 30B

The circumferential speed (S3) of the roll assembly 30 can be substantially the same as that of the second roller assembly 26 so as to maintain the elastic film in a stretched condition when entering the roll assembly 30. In an alternate embodiment, the roll assembly 30 can operate at a circumferential speed higher than that of the second roller assembly 26 assembly thereby further machine direction stretching the elastic film and, and in some implementations, also neck stretching of the nonwoven webs prior to entering the roll assembly 30.

In addition to the MD stretch and tension imparted by the upstream assemblies, a CD stretch is imparted on the stacked film and nonwoven webs through use of the grooved roll assembly 30. This multi-dimensional strain is believed to cause a controlled rupturing of the film. The inter-meshing grooved rolls 30A, 30B, for instance, can form an irregular nip 31 and each roller includes a series of alternating ridges and grooves. The rolls 30A, 30B are arranged such that their respective ridges and grooves are off-set from one another and inter-mesh. In other words, the ridges of the upper grooved roll 30A are positioned so as to extend into the grooves of the second or lower grooved roll 30B and between the ridges of the second grooved roll 30B. Similarly, the ridges of the second grooved roll 30B are positioned so as to extend into the grooves of the first grooved roll 30A and between the ridges of the first grooved roll 30A. In certain embodiments, the ridges and grooves run concentrically around the entirety of the rolls 30A, 30B. The grooves or troughs of such grooved rolls may be machined into a roll, may be formed by a series of elements such as discs, or may be any other means that provides the functional structure shown.

As the stack 28 is pulled through the nip 31 the engagement at the ridges of the opposed grooved rolls 30A, 30B causes the components forming the stack 28 to be additionally stretched in the widthwise or cross-machine direction. The biaxial stretching forces and heat also act together act to cause the regionally controlled rupturing of the elastic film. In addition, in the areas on or about the top of the ridges, pressure and heat is applied via the rolls 30A, 30B which also facilitates melt fusing between one of more layers within the stack. With respect to the use of such inter-meshing grooved roll assemblies 30, the amount of CD stretch imparted to the unengaged sections, and the amount of pressure imparted to the engaged sections atop the ridges, is a function of the engagement depth to which the grooved rolls are set; the deeper the grooved rolls mesh, the greater is the percent extension in the CD. The opposed grooves and ridges engage or mesh with one another to a selected depth. Further, by arranging the gap distance between the rolls, the nonwoven material can be acted upon to varying degrees. The engagement depth can be at least about 5 mm and in certain embodiments may be between about 5 mm and about 20 mm or between about 6 mm and about 15 mm. The CD stretch imparted to the material in the grooved roll assembly desirably causes the CD width of the outer nonwoven fabrics to increase at least about 5% and in certain embodiments can result in the CD width of the outer nonwoven fabrics increasing between about 5-20%, between about 5-15%, between about 8-15% or even between about 6-12%.

The depth of the groves and/or the height of the ridges can vary considerably as it is the engagement depth that more directly drives the degree of CD stretch. However, the depth and height of the ridges and grooves is selected relative to the stack height so as to ensure that the stack is not significantly pinched or severed while within the grooved roll nip. In order to effectively engage the sheet stack 28 while in the nip 31 without severing the stack, neither the nip gap distance between the opposed grooves and ridges, the apex nip gap, nor the nip gap distance between sidewalls of adjacent ridges, the side nip gap, is substantially smaller than the height of the stack 28. The height of the stack or ‘stack height’ being measured by placing each of the sheets of appropriate size upon one another and measuring in accordance with the method for measuring fabric thickness as described herein. The apex nip gap may be slightly smaller than the stack height but is desirably not less than 100% of the stack height. In certain embodiments, the apex nip gap and side nip gap are each at least 100% the stack height and in further embodiments is at least 110%, 120%, 150% or even 200% of the stack height. In certain embodiments, the side nip gap may be larger than the apex nip gap. In addition, the shape of the top of the ridges are desirably rounded including for example having a substantially semi-circular shape.

It will be apparent that the number of engaging ridges and the frequency of the ridges may be greatly varied. By way of example only, ridges having a height between about 0.5 cm and about 2 cm will be suitable for many embodiments having relatively lower basis weight materials. In certain embodiments, a single roll may have between about 0.25 ridges per cm and about 7 ridges per cm, and in some embodiments from about 0.5 ridges per cm and 5 ridges per cm, and in still other embodiments between about 1 and about 4 ridges per cm. In addition, the peak-to-peak distance of the ridges can also vary such as in certain embodiments being between about 4 cm to about 0.2 cm, and in other embodiments being between about 3 cm to about 0.25 cm, and in still further embodiments being between about 2 cm and about 0.5 cm. Still further, in certain embodiments the frequency or spacing of the ridges may vary across the CD length of the roll.

In some implementations to achieve melt fusing as between the layers and (concurrently) rupturing of the film, adequate stretching forces and heat is applied to the outer fabric layers and elastic film. The temperature of the facings and film layers should not be so high such that it causes, together with the pressures applied via the stretching forces, the film and/or fibers to melt a significant amount. In this regard, if the film melts and fibers become fully embedded in the film elasticity of the resulting laminate may be degraded. Further, if fibers are significantly melted and compressed into film-like segments this can create hard spots and/or areas that provide a generally rougher hand-feel.

Heating of the layers may be achieved by any one of various means known in the art. In certain embodiments, the stack may be heated immediately prior to entering the nip of the roll assembly 30 such as by the use of heated rolls, IR heaters, convection heaters, etc. With respect to the embodiment depicted in FIG. 1, one or more rolls of the first and/or second roll assemblies 22, 26 can be heated. Additionally and/or alternatively, the layers may be heated while against the rolls by heating one or both of the rolls 30A, 30B. When using the rolls to heat the layers, it will be appreciated that one or more of the layers may be directed along a section of the outer perimeter of a roll prior to entering the nip in order to increase the length of time the layer directly contacts and is heated by the roller.

In one aspect, one or both of the rolls can be heated to a temperature between about 65 °C-145 °C, between about 70 °C-120 °C or between about 80-98 °C. However, it will be appreciated that the temperature of the one or more rollers will vary with respect to various factors including the speed of the stack, the softening points of the polymers used and the force applied to the materials. In certain embodiments, at least one or both rolls 30 are heated to a temperature of at least about 5 °C, 10 °C, 15 °C or even 20 °C higher than the Vicat softening temperature of the elastomeric film. In certain embodiments, one or both rolls may be between about 5-90 °C, 10-75 °C or even 10-50 °C higher than the Vicat softening temperature of the elastomeric film. Further, in certain embodiments both rolls can be heated but to a temperature below the melting temperature of the nonwoven fabrics. The Vicat softening temperature may be determined in accordance with ASTM D1525-09.

In accordance with the present disclosure, after having been bonded together in the bonding and perforating device/roll assembly 30, a cohesive laminate 40 is formed and contacts a tension device 32. The tension device 32 is for maintaining elastic film 25 in a stretched state after apertures have been formed in the film. By maintaining the elastic film 25 in a stretched state after the apertures are formed, the process allows for better control over the air permeability properties of the resulting nonwoven composite laminate 40.

As shown in FIG. 1, in order to maintain the elastic film 25 in a stretched state, the laminate 40 enters a tension device 32. The tension device 32 can be any suitable device capable of keeping the elastic film 25 in a stretched state without allowing the film to completely retract. In the embodiment illustrated in FIG. 1, the tensioning device 32 includes a nip 33 formed between a first guide roll 34A and a second guide roll 34B. The rolls 34A and 34B rotate in opposite directions and rotate at a circumferential speed (S4) that can be the same speed as the rolls 30A and 30B in order to maintain the elastic film 25 in generally the same stretched state as when the film has been apertured and bonded. Alternatively, the rolls 34A and 34B can operate at a slightly slower circumferential speed than the rolls 30A and 30B in order to allow the elastic film 25 to retract a controlled amount. For instance, the tension device 32 can be operated such that the elastic film retracts by no more than about 60%, such as by no more than about 50%, such as by no more than about 40%, such as by no more than about 30%, such as by no more than about 20%, such as by no more than about 10% in the machine direction. For instance, within the nip 33, the elastic film 25 can still be at a stretch ratio of about 1.5 or greater, such as about 2 or greater, such as about 2.5 or greater, such as about 3 or greater, such as about 3.5 or greater, such as about 4 or greater, such as about 4.5 or greater, such as about 5 or greater, and less than about 11, such as less than about 9, such as less than about 8, such as less than about 7.5.

Once exiting the tension device 32, the laminate or nonwoven composite 40 is then allowed to retract and can be fed directly into a converting line for incorporation into a desired end product or, alternatively, as shown in FIG. 1, can be wound on a winder roll 42 for future use and/or converting. The supply roll 42, for instance, can operate at a peripheral speed (S5) that is less than the peripheral speed (S4) of the tension device 32 in order to allow the elastic film 25 to retract. The laminate 40 can be somewhat in still a tension state when wound onto the roll 42 or can be completely relaxed. In one aspect, the elastic film can retract and wound onto the supply roll 42 such that the film maintains less than about 35% stretch, such as less than about 30% stretch, such as less than about 25% stretch, such as less than about 20% stretch, such as less than about 15% stretch, such as less than about 10% stretch, such as less than about 5% stretch in relation to the amount of stretch contained in the elastic film 25 in the bonding and perforating device 30.

In the embodiment illustrated in FIG. 1, the tension device 32 includes a pair of opposing rollers 34A and 34B. Alternatively, the tension device 32 can have an S-wrap configuration similar to rolls 22A and 22B for maintaining the elastic film 25 under tension after exiting the bonding and perforating device 30.

The amount of time that the elastic film 25 is to be maintained in a stretched state after being perforated can vary depending upon different factors including the process configuration and the materials used to form the different layers. In one aspect, the elastic film 25 need only be maintained in a stretched state for a very short period of time in order to provide proper control over the air permeability properties of the resulting nonwoven composite. For instance, the tension device 32 can be spaced from the bonding and perforating device 30 so as to maintain the elastic film 25 under tension for a time of less than about 10 seconds, such as less than about 8 seconds, such as less than about 6 seconds, such as less than about 4 seconds, such as less than about 2 seconds. In one aspect, the elastic film 25 is maintained in a stretched state after the apertures have been formed for a time of less than about 1 second, such as less than about 0.8 seconds, such as less than about 0.6 seconds, such as less than about 0.4 seconds, and generally greater than about 0.1 seconds, such as greater than about 0.2 seconds.

It was discovered that by maintaining the elastic laminate 40 in a stretched state and particularly the elastic film 25 in a stretched state after the apertures have been formed for a relatively short period of time post-bonding results in an unexpected and dramatic increase in air permeability of the elastic composite that would not otherwise occur. Although unknown, it is believed that maintaining the laminate in a stretched state can allow the elastic film 25 to cool for preventing the apertures from closing and/or also has an effect on the nonwoven materials that are point bonded to the elastic film. Maintaining the laminate 40 in a stretched state, for instance, is believed to prevent fibers in the nonwoven web materials from interfering with the air permeability properties of the nonwoven composite even when the nonwoven web materials contain very fine fibers or high density fibers.

As will be described in greater detail below, being able to better control the air permeability properties of the elastic nonwoven composite allows for the use of low temperature polymers while still being able to produce composites having elevated and desired air permeability properties. In the past, for instance, low temperature polymer materials contained in the elastic film and/or in the nonwoven web materials caused plugging or closure of the apertures formed in the elastic film. Due to the process of the present disclosure, however, these low temperature polymer materials can be incorporated into the nonwoven composite while still producing laminates having desired air permeability properties.

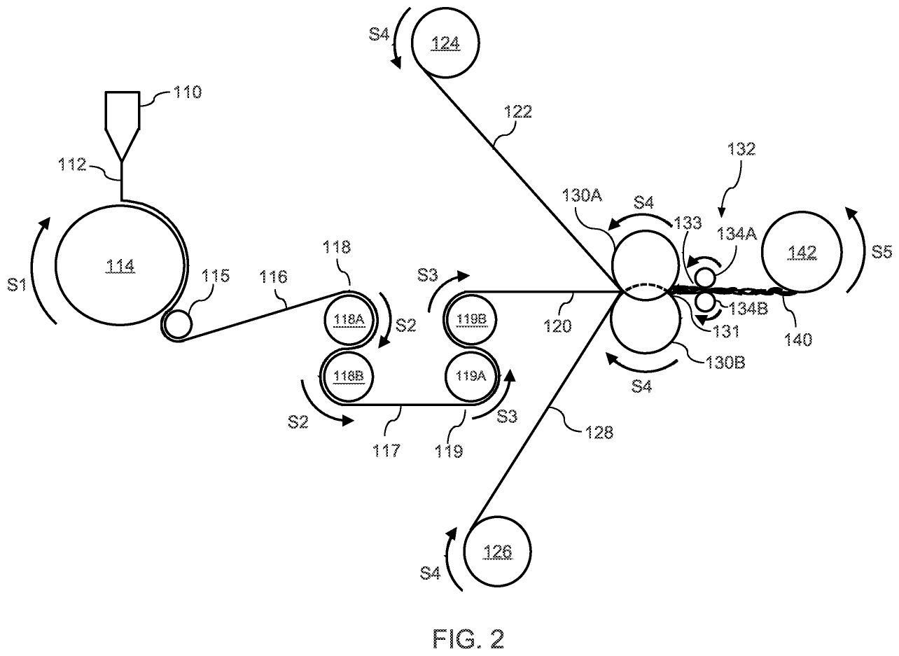

Referring to FIG. 2, an alternative embodiment of a process for producing a nonwoven composite made in accordance with the present disclosure is shown. In this embodiment, elastomeric polymer is fed from a hopper (not shown), melted and directed to an extrusion apparatus 110 such as a film die. The extruded polymer 112 is directed onto a chill roll 114 to form a single-layered elastic film 116. If a multilayer film is to be produced, the multiple layers may be co-extruded together and directed onto the chill roll. Typically, the chill roll 114 is kept at a temperature sufficient to solidify and quench the extruded polymer and form a film thereon. In certain embodiments, the chill roll may be maintained at a temperature between about 20 °C to 60 °C.

To achieve the desired elastic properties of the film, various parameters of the film formation and stretching operation are selectively controlled. For example, the circumferential speed of the chill roll may be higher than the extrusion speed of the molten polymer exiting the film die. This disparity in rates causes the film to stretch and/or orient to a certain degree in the MD. After formation of the film on the chill roll, the film may be drawn or stretched in the MD as generally described above. In some embodiments, for example, the formed film is cumulatively stretched in the machine direction at a draw ratio of from about 3 to about 12, in some embodiments from about 3 to about 9, and in some other embodiments from about 4 to about 7. The draw ratio may be determined by dividing the linear speed of the film exiting the stretching operation by the linear speed of the film entering the stretching operation.

In reference to the embodiment depicted in FIG. 2, the elastic film 116 is stretched in the machine direction by passing through a series of rolls with the downstream rolls traveling at a relatively higher circumferential speed than the preceding upstream rolls. In this regard, the elastic film 116 is directed from the chill roll 114 and cooperating guide roll 115 to an s-wrap roller assembly 118 comprising at least stacked first and second rollers 118A, 118B. The rolls 118A, 118B of the s-wrap assembly operate at circumferential speed (S2) that is faster than the circumferential speed (S1) of the chill roll 114. This speed differential acts to stretch the elastic film 116 in the machine direction. Optionally, the stretched elastic film 116 film may then be directed to a further downstream drive roll assembly 119, including stacked first and second rollers 119A, 119B, operating a circumferential speed (S3) that is greater than the circumferential speed (S2) of the upstream or first roller assembly 118. This operation imparts further incremental stretching and elongation of the elastic film 117. While two sets of roller assemblies are illustrated as part of the system depicted in FIG. 2, it should be understood that the number of assemblies may vary as desired, depending on the overall level of stretch that is desired and the degrees of stretching between each of the assemblies.

The stretched film 120 exits the s-wrap rollers 119A, 119B and is then directed to a further downstream bonding and perforating device, in this case a groove roll assembly 130 having inter-meshing grooved rolls 130A, 130B. The outer facing materials 122, 128 are directed to be superimposed with the elastic film 120, forming a fabric/film/fabric stack just prior to entering the nip 131 of the grooved roll assembly 130. In this regard, the outer fabrics may optionally be made in-line with the elastic film and/or provided from a supply roll. In reference to FIG. 2, a first nonwoven fabric 122 is unwound from a first supply roll 124 and a second nonwoven web 128 may be unwound from a second supply roll 126. The nonwoven webs 122, 128 may then be directed to be in superposition with opposite surfaces of the elastic film 120 just prior to entering the nip 131 of grooved roll assembly 130.

The circumferential speed (S3) of the upstream roller assembly 119 is lower than the circumferential speed (S4) of the grooved rollers 130A, 130B. Thus, as a result of the speed differential, the film 120 is further elongated in the machine direction and in a stretched state as it enters the nip 131 of the roll assembly 130 together with the nonwoven fabrics 122, 128. As discussed above, as a result of the heat and engagement with the grooved rolls, the stack is both stretched in the CD and cohesively bonded together.

From the roll assembly 130, the laminate 140 is fed to a tension device 32 that, in this embodiment, comprises a nip 133 formed between roll 134A and roll 134B. The rolls 134A and 134B engage the laminate 140 and turn at a speed that inhibits the elastic film 120 from retracting by more than 60%. More particularly, the tension device 132 is operated such that the film 120 does not retract more than about 50%, such as by no more than about 40%, such as by no more than about 30%, such as by no more than about 20%, such as by no more than about 10%. In this manner, the elastic film 120 is maintained in a stretched state after the apertures are formed in the film by the rollers 130A and 130B. By maintaining the elastic film in a stretched state, the air permeability properties of the laminate 140 can be dramatically and unexpectedly improved.

In the present embodiment as shown in reference to FIG. 2, the composite elastic laminate 140 is thereafter wound on the winding roll 142 while under substantially reduced MD tension. In this regard, composite laminate 140 is kept under sufficient tension for processing but is allowed to substantially retract by employing a slower circumferential speed (S5) for the take-up roll 142 relative to the speed of the upstream rolls 134A, 134B. In this regard, the elastic composite may be allowed to retract at least about 60%, such as at least about 70%, such as at least about 80%, such as at least about 90%, or can retract 100%. Relaxing the laminate 140, for instance, can result in the elastic film 120 having its original pre-stretched machine direction length. Retraction of the elastic film 120 can cause the bonded nonwoven webs to form gathers in the composite. The resulting elastic laminate thus becomes extensible in the machine direction at least to the extent that the gathers or buckles in the web may be pulled back out flat and allow the elastic film to elongate.

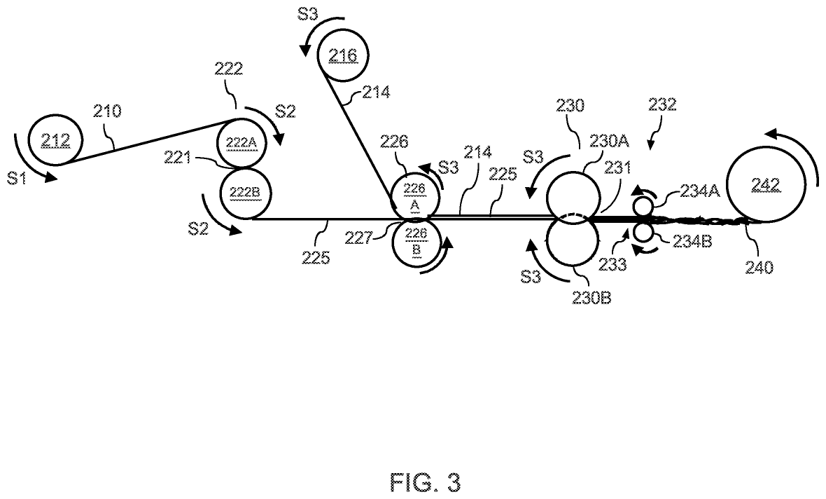

Referring to FIG. 3, still another embodiment of a process for forming nonwoven composites in accordance with the present disclosure is shown. In this embodiment, only a single nonwoven web material is being bonded to the elastic film layer.

As shown in FIG. 3, an elastic film 210 is provided and unwound from a first supply roll 212. The film 210 travels away from the first supply roll 212 and towards a first roller assembly 222 that includes a first roll 222A and a second roll 222B. The pair of rolls 222A and 222B are positioned proximate one another so as to form a nip 221. The circumferential speed of the first roller assembly 222 can be the same as the speed of the unwind roll 212.

The elastic polymer film 210 passes through the nip 221 and travels in a direction towards and enters a nip 227 of a second roller assembly 226 comprising a pair of drive rollers 226A and 226B. The circumferential speed of the second roller assembly 226 can be controlled in order to stretch the elastic film 225 in the machine direction. As described above, the elastic film 225 can be stretched from about 150% to about 1,200%, including all increments of 1% therebetween.

As shown in FIG. 3, a fabric 214 can be unwound from a second supply roll 216 and directed towards the nip 227 of the second roller assembly 226. The fabric 214 is superimposed with the elastic film 225 while the film is in a stretched state and fed to a bonding and perforating device 230 which can comprise a pair of rolls 30A and 30B. The rolls 30A and 30B can perforate the film and form discrete bond sites between the elastic film 225 and the fabric 214.

In accordance with the present disclosure, the bonded and apertured laminate 40 is maintained in a stretched condition by a tension device 232. The tension device 232 can comprise a pair of spaced apart rolls 234A and 234B that form a nip 233. The rolls 234A and 234B can rotate at a speed that maintains the elastic film 225 in a stretched state such that the film retracts by no more than about 60%, such as by no more than about 50%, such as by no more than about 40%, such as by no more than about 30%, such as by no more than about 20%, such as by no more than about 10%. As described above, maintaining the elastic film 225 in a stretched state after the apertures are formed has been found to dramatically improve and increase the air permeability of the laminate 240.

Once exiting the tension device 232, the laminate 40 is allowed to retract and is wound on a supply roll 242.

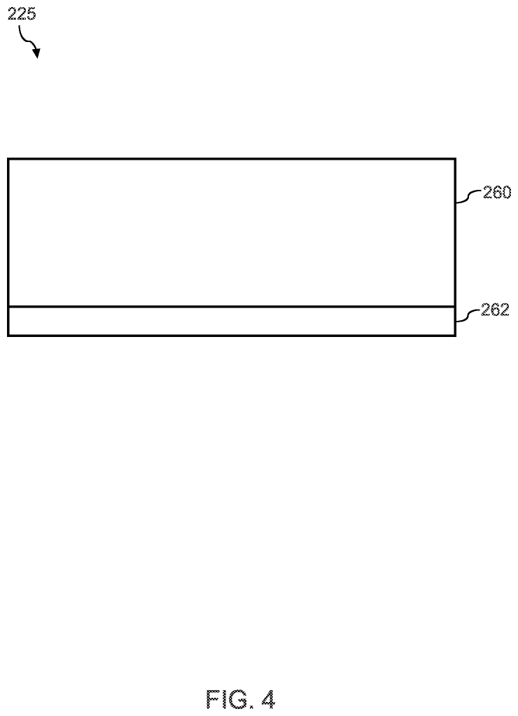

In the embodiment illustrated in FIG. 3, in one aspect, the elastic film 225 being fed through the process can be a multi-layer film. For example, as shown in FIG. 4, the elastic film 225 can include a primary film layer 260 adjacent a skin layer 262. The skin layer 262 can be positioned on a side of the primary film layer 260 opposite the fabric 214. In other words, the primary film layer 260 can be positioned in between the skin layer 262 and the fabric layer 214. The skin layer 262 can be formed from a polymer that is less tacky than the primary film layer 260 and thus can prevent the material from sticking to itself during winding. The skin layer 262 can be made from a non-elastomeric polymer or can be made from a mixture of a non-elastomeric polymer and an elastomeric polymer. Of particular advantage, the skin layer 262 can be made from a low temperature polymer that would have interfered with the air permeability properties of the elastic nonwoven in the past. Through the process of the present disclosure, however, a skin layer 262 containing a low temperature polymer can be used without adversely interfering with the apertures that are formed into the film. In one aspect, for instance, the skin layer 262 can be made from or can include a polyethylene polymer, such as a linear low density polyethylene polymer that can have a melting temperature of less than about 150 °C, such as less than about 140 °C, such as less than about 130 °C, such as less than about 120 °C, such as less than about 110 °C.

Elastic laminates made in accordance with the present disclosure can have various different properties. In certain embodiments, the elastic laminate can have, as fully contracted and in an unstretched state, a basis weight of at least about 15 g/m² and in certain embodiments may have a basis weight of at least about 25, 30, 35 or 40 g/m² and less than about 120, 90, 75, 65 or 60 g/m². In certain embodiments, in a relaxed and unstretched state, the elastic film can comprise at least 10% by weight of the laminate such as for example comprising at least 10%, 15%, 20%, 25%, 30%, 35%, 40% or 45% of the laminate. Further, in a relaxed and unstretched state, the elastic film can comprise less at least about 10% by weight of the laminate such as for example comprising at least about 10%, 15%, 20%, and 25% of the laminate. Further, in a relaxed and unstretched state, the elastic film can comprise less than about 45%, 40%, 35% or even 30% by weight of the laminate. The outer fabric(s) may comprise between about 55-90%, by weight of the laminate such as comprising at least about 55%, 60%, 65% or 70% by weight of the laminate and/or comprising less than about 90%, 85%, 80% or 75% by weight of the elastic laminate.

As described above, the process of the present disclosure is designed to control and increase the air permeability properties of the elastic laminate or nonwoven composite. In general, the elastic laminate can have a permeability of from about 10 CFM to about 1,500 CFM, including all increments of 1 CFM therebetween. For example, the elastic laminate can have an air permeability of greater than about 20 CFM, such as greater than about 25 CFM, such as greater than about 30 CFM, such as greater than about 40 CFM, such as greater than about 50 CFM, such as greater than about 60 CFM, such as greater than about 70 CFM, such as greater than about 80 CFM, such as greater than about 90 CFM, such as greater than about 100 CFM, such as greater than about 110 CFM, such as greater than about 120 CFM, such as greater than about 130 CFM, such as greater than about 140 CFM, such as greater than about 150 CFM, such as greater than about 160 CFM, such as greater than about 170 CFM, such as greater than about 180 CFM, such as greater than about 190 CFM, such as greater than about 200 CFM. The air permeability is generally less than about 1,000 CFM, such as less than about 700 CFM, such as less than about 500 CFM, such as less than about 300 CFM, such as less than about 200 CFM, such as less than about 150 CFM. Of particular advantage, the elastic laminate of the present disclosure can contain a low temperature polymer either in a nonwoven web material or in a skin layer on the elastic film and still have an air permeability of greater than about 10 CFM, such as greater than about 20 CFM, such as greater than about 25 CFM, such as greater than about 30 CFM, such as greater than about 40 CFM, such as greater than about 50 CFM. In the past, low temperature polymers interfered with aperture formation and/or aperture retention. Thus, incorporating low temperature polymers into elastic laminates and maintaining desired and elevated air permeability properties was problematic. The process of the present disclosure, however, unexpectedly and dramatically overcomes problems experienced in the past.

In addition, despite the relatively low basis weights and excellent breathability, the elastic laminates provide desirably elastic properties. In this regard, the elastic laminates can provide for and have a percent stretch at 2000 g-f of greater than about 75%, 80%, 85%, 90%, 95% or even 100%. Additionally and/or alternatively, the elastic laminate can provide or have a percent stretch at 2000 g-f of less than about 260%, 255%, 250%, 245%, 340% or even 235%.

A wide variety of elastic films are believed suitable for use in connection with the present disclosure. In this regard, elastic films can comprise either monolayer or multi-layer films. Further, a variety of different elastomeric polymers, and blends thereof, are believed suitable for use in the present invention. In certain embodiments, the elastomeric films and corresponding polymers predominantly comprise thermoplastic polymers having a softening point below that of the fabrics forming the outer layers. Generally, the polymeric portion of the elastic film will desirably comprise greater than 85%, 90%, 92%, 95%, or 98% elastomeric polymer(s). The specific type and amounts of elastomer selected will vary with the desired properties including, in particular, the elastic properties such as the % stretch and recovery force. Any of a variety of thermoplastic elastomers may generally be utilized as the elastic film of the elastic composite laminate of the present invention. Such polymers include elastomeric polyesters, elastomeric polyurethanes, elastomeric polyamides, elastomeric styrenic polymers, elastomeric polyolefins, and so forth.

In certain embodiments, the polymeric portion of the film elastic film can comprise, predominantly or entirely, olefin elastomers such as comprising greater than 55%, 75%, 85%, 90%, 95% or 97% elastomeric olefin polymers. In one aspect, the elastic film can comprise semi-crystalline polyolefin polymer(s). Semi-crystalline polyolefins have or are capable of exhibiting a substantially regular structure. For example, semi-crystalline polyolefins may be substantially amorphous in their undeformed state, but form crystalline domains and/or increased polymer chain alignment upon stretching. The degree of crystallinity of the olefin polymer may be from about 3 percent to about 30 percent, in some embodiments from about 5 percent to about 25 percent, and in some embodiments, from about 5 percent and about 15 percent. The semi-crystalline polyolefin may have a melting temperature of from about 40 °C to about 120 °C, in some embodiments from about 45 °C to about 90 °C, and in some embodiments, from about 50 °C to about 80 °C.

Particularly suitable polyethylene copolymers are those that are “linear” or “substantially linear.” The term “substantially linear” means that, in addition to the short chain branches attributable to comonomer incorporation, the ethylene polymer also contains long chain branches in the polymer backbone. “Long chain branching” refers to a chain length of at least 6 carbons. Each long chain branch may have the same comonomer distribution as the polymer backbone and be as long as the polymer backbone to which it is attached. Preferred substantially linear polymers are substituted with from 0.01 long chain branch per 1000 carbons to 1 long chain branch per 1000 carbons, and in some embodiments, from 0.05 long chain branch per 1000 carbons to 1 long chain branch per 1000 carbons. In contrast to the term “substantially linear”, the term “linear” means that the polymer lacks measurable or demonstrable long chain branches. That is, the polymer is substituted with an average of less than 0.01 long chain branch per 1000 carbons.

Exemplary semi-crystalline polyolefins include polyethylene, polypropylene, blends and copolymers thereof. In one particular embodiment, an ethylene polymer is employed that is a copolymer of ethylene and an alpha-olefin, such as a C₃-C₂₀ alpha-olefin or C₃-C₁₂ alpha-olefin. Suitable alpha-olefins may be linear or branched (e.g., one or more C₁-C₃ alkyl branches, or an aryl group). Specific examples include 1-butene; 3-methyl-1-butene; 3,3-dimethyl-1-butene; 1-pentene; 1-pentene with one or more methyl, ethyl or propyl substituents; 1-hexene with one or more methyl, ethyl or propyl substituents; 1-heptene with one or more methyl, ethyl or propyl substituents; 1-octene with one or more methyl, ethyl or propyl substituents; 1-nonene with one or more methyl, ethyl or propyl substituents; ethyl, methyl or dimethyl-substituted 1-decene; 1-dodecene; and styrene. Particularly desired a-olefin comonomers are 1-butene, 1-hexene and 1-octene. The ethylene or propylene content of such copolymers may be from about 60 mole percent to about 99 mole percent, in some embodiments from about 80 mole percent to about 98.5 mole percent, and in some embodiments, from about 87 mole percent to about 97.5 mole percent. The alpha-olefin content may likewise range from about 1 mole percent to about 40 mole percent, in some embodiments from about 1.5 mole percent to about 15 mole percent, and in some embodiments, from about 2.5 mole percent to about 13 mole percent. Ethylene polymer elastomers can have a density of from about 0.85 g/cm³ to about 0.90 g/cm³, and in certain embodiments between about 0.86 to about 0.89 g/cm³.

Any of a variety of known techniques may generally be employed to form the elastomeric polyolefins. For instance, olefin polymers may be formed using a free radical or a coordination catalyst (e.g., Ziegler-Natta). Preferably, the olefin polymer is formed from a single-site coordination catalyst, such as a metallocene catalyst. Such a catalyst system produces ethylene copolymers in which the comonomer is randomly distributed within a molecular chain and uniformly distributed across the different molecular weight fractions. Olefin elastomers and methods of making the same are described, for instance, in U.S. Pat. No. 5,272,236 to Lai et al., U.S. Pat. No. 5,278,272 to Lai et al., U.S. Pat. No. 5,472,775 to Obijeski et al., U.S. Pat. No. 5,539,056 to Yang et al., U.S. Pat. No. 7,582,716 to Liang et al., the contents of which are incorporated herein in by reference to the extent consistent herewith.

Exemplary commercially available polyolefin-based thermoplastic elastomers suitable for use in the elastomeric film include VISTAMAXX™ (propylene-based elastomer, available from ExxonMobil Chemical, Houston, Tex.), INFUSE™ (olefin block copolymers, available from Dow Chemical Company, Midland, Mich.), VERSIFY™ (propylene-ethylene copolymers, available from the Dow Chemical Company, Midland, Mich.), ENGAGE™ (ethylene octane copolymer, available from Dow Chemical, Houston, Tex.), and NOTIO 0040 and NOTIO 3560 (available from Mitsui Chemical (USA), New York, N.Y. In one particularly suitable embodiment, the polyolefin-based thermoplastic elastomer is VISTAMAXX™ 6102FL.

In addition, also believed suitable are elastomers comprising block copolymers such as those that contain blocks of a monoalkenyl arene and a saturated conjugated diene. The monoalkenyl arene block(s) may include styrene and its analogues and homologues, such as o-methyl styrene; p-methyl styrene; p-tert-butyl styrene; 1, 3 dimethyl styrene p-methyl styrene; etc., as well as other monoalkenyl polycyclic aromatic compounds, such as vinyl naphthalene; vinyl anthrycene; and so forth. Preferred monoalkenyl arenes are styrene and p-methyl styrene. The conjugated diene block(s) may include homopolymers of conjugated diene monomers, copolymers of two or more conjugated dienes, and copolymers of one or more of the dienes with another monomer in which the blocks are predominantly conjugated diene units. Preferably, the conjugated dienes contain from 4 to 8 carbon atoms, such as 1,3 butadiene (butadiene); 2-methyl-1,3 butadiene; isoprene; 2,3 dimethyl-1,3 butadiene; 1,3 pentadiene (piperylene); 1,3 hexadiene; and so forth. The amount of monoalkenyl arene (e.g., polystyrene) blocks may vary, but typically constitute from about 8 weight percent to about 55 weight percent, in some embodiments from about 10 weight percent to about 35 weight percent, and in some embodiments from about 15 weight percent to about 25 weight percent of the copolymer. Thermoplastic elastomeric copolymers of this type are available from Kraton Polymers LLC of Houston, Tex. under the trade name Kraton™. Kraton™ polymers include styrene-diene block copolymers, such as styrene-butadiene, styrene-isoprene, styrene-butadiene-styrene, styrene-isoprene-styrene, and styrene-isoprene/butadiene-styrene. Kraton™ polymers also include styrene-olefin block copolymers formed by selective hydrogenation of styrene-diene block copolymers. Examples of such styrene-olefin block copolymers include styrene-(ethylene-butylene), styrene-(ethylene-propylene), styrene-(ethylene-butylene)-styrene, styrene-(ethylene-propylene)-styrene, styrene-(ethylene-butylene)-styrene-(ethylene-butylene), styrene-(ethylene-propylene)-styrene-(ethylene-propylene), and styrene-ethylene-(ethylene-propylene)-styrene. Also suitable are polymers composed of an A-B-A-B tetrablock copolymer such as, for example, a styrene-poly(ethylene-propylene)-styrene-poly(ethylene-propylene) (“S-EP-S-EP”) block copolymer. Various suitable styrenic block copolymers are described in, but not limited to, U.S. Pat. No. 4,663,220 to Wisneski et al., U.S. Pat. No. 5,093,422 to Himes, U.S. Pat. No. 5,332,613 Taylor et al., U.S. Pat. No. 8,604,129 Thomas, and U.S. Pat. No. 8,980,994 Wright et al.

In certain embodiments the film extrudate and corresponding elastic film can comprise a mixture of one or more different elastic polymers. By way of example, blends comprising a mixture of styrenic block co-polymers together with polyolefin elastomers are well suited for use in connection with the present invention. Blends comprising between 55-95% polyolefin elastomer(s) and 5-45% styrenic block co-polymer(s) provide a good combination of retractive force and cost. Alternatively, blends comprising between 5-45% polyolefin elastomer(s) and 55-95% styrenic block co-polymer(s) provide excellent stretch and recovery properties. Still further, in certain embodiments the film extrudate and corresponding elastic film can comprise a mixture of one or more elastic polymers together with a minor portion of inelastic polymers. By way of example, the elastomeric polymer composition may include a mixture of semi-crystalline ethylene and propylene polymers. For example, in certain embodiments the elastomeric polymer, such as an ethylene polymer, comprises between about 80 and about 99% or between about 85 and about 95% of the polymeric portion of the extrudate and film and the inelastic polymer, such as a propylene polymer, comprises between about 1 and about 20% or between about 5 and about 15% of the polymeric portion of the extrudate and film.

The film may also include additional components as desired to achieve or enhance various properties. For example, in addition to the elastomeric polymers, the film may optionally also include fillers, colorants, plasticizers, tackifiers, antioxidants, and/or other know additives. In certain embodiments, the film may include opacifying fillers or colorants, such as for example TiO₂, in an amount between about at 0.1 to about 5% by weight or between about 0.5 or to about 3% by weight of the film extrudate and/or elastic film. In still further embodiments, heat and/or UV stabilizer packages may be used, for example Eastman Regalrez 1049 or 1126, in amounts between about 2-10 wt. % of the film extrudate and/or elastic film.

As described above, in one embodiment, the elastic film can include a skin layer. Skin layers, for instance, are particularly well suited for applications where the laminate only contains one or more nonwoven web materials bonded to a single side of the film. Skin layers can provide anti-blocking characteristics and can provide other various advantages. In accordance with the present disclosure, an elastic film can include a skin layer that contains a low temperature polymer. The low temperature polymer, for instance, can have a melting point of less than about 150 °C, such as less than about 140 °C, such as less than about 130 °C, such as less than about 120 °C, such as less than about 110 °C, such as less than about 100 °C, such as less than about 90 °C, such as less than about 80 °C, and generally greater than about 50 °C, such as greater than about 70 °C, such as greater than about 80 °C. The low temperature polymer can also have a VICAT softening temperature of less than about 125 °C, such as less than about 120 °C, such as less than about 110 °C, such as less than about 100 °C, such as less than about 90 °C, such as less than about 80 °C, such as less than about 70 °C, such as less than about 60 °C, such as less than about 55 °C, and greater than about 40 °C. Optionally, the low temperature polymer can have a Shore A Hardness of less than about 125, such as less than about 110, such as less than about 100, such as less than about 95, such as less than about 90, and greater than about 50, such as greater than about 65.

Low temperature polymers can be incorporated into the skin layer without adversely impacting the air permeability properties of the laminate. The skin layer, for instance, can contain one or more low temperature polymers in an amount greater than about 30% by weight, such as in an amount greater than about 50% by weight, such as in an amount greater than about 70% by weight, such as in an amount greater than about 90% by weight. In one application, the skin layer can be made entirely from one or more low temperature polymers. In one embodiment, the low temperature polymer can be a polyolefin polymer, such as a polyethylene homopolymer or copolymer. In one aspect, for instance, the skin layer can contain a linear low density polyethylene polymer.

At least one support material, such as a fabric, is employed as an outer facing of the multi-layer composite. Fabrics utilized in association with the present disclosure will be porous in nature providing numerous direct or tortuous pathways there through. In this regard, the fabric may comprise one or more fibrous materials having desired physical attributes, such as pleasing hand, softness, tensile strength and/or other desired attributes. Importantly, the fabric provides CD strength properties to the elastic laminate necessary for the associated processing, converting, and manufacturing of the ultimate article and/or for sufficient durability in use. In this regard, the fabric can have a tensile strength of at least about 50 g-f including for example having a tensile strength greater about 100 g-f, 150 g-f, 200 g-f, 250 g-f or even 300 g-f and, in certain embodiments, a tensile strength less than about 5000 g-f, 3000 g-f, 2500 g-f, 2000 g-f or even 1500 g-f. In addition, the fabric desirably provides a pleasing hand. The fabric can also be selected so as to also be highly drapable and/or have a low bending modulus.

Fabrics suitable for use in the present invention include, but are not limited to, woven or knitted fabrics as well as nonwoven fabrics such as those made by meltblowing, spunbonding, air-laying, carding, and/or hydroentangling processes. Examples of suitable fabrics and methods of making the same include, but are not limited to, those described in U.S. Pat. No. 4,548,856 to Ali Kahn et al., U.S. Pat. No. 5,492,751 to Butt et al., U.S. Pat. No. 6,224,977 Kobylivker et al., U.S. Pat. No. 8,603,281 to Welch et al., WO99/32699 to Stokes et al., and WO16/080960 to Kupelian et al. Generally speaking, in order to limit the negative impact on the retractive force, in many embodiments it will be advantageous to utilize relatively lower basis weight fabrics. In this regard, the fabrics desirable have a basis weight less than about 30 g/m². In certain embodiments, the fabrics can have a basis weight less than about 25 g/m², 20 g/m², 18 g/m² or even 16 g/m² and further, in certain embodiments, can have a basis weight in excess of about 5 g/m², 7 g/m² or even 8 g/m². Polymers suitable for use in the nonwovens are not believed particularly limited an include polyolefins, polyesters, polyamides and so forth. In certain embodiments, the polymeric portion of the fibers can comprise at least 50%, 60%, 70%, 80% or 100% of a propylene polymer or ethylene polymer. In addition, as is known in the art, the fibers can comprise continuous or staple length fibers and still further may comprise multicomponent or multiconstituent fibers.

Further, in order to achieve still greater drapability, the fabric is desirably treated in one or more additional respects such as by the use of internal softening agents, external softening agents and/or mechanical softening treatments. By way of example, mechanical treatment of a web may be carried out by a number of different methods such as micro-creping, cold embossing, breaker bar treatment, neck stretching, and combinations thereof. However, still other methods known in the art may also be used. Examples of various methods of mechanically treating fabrics to impart improved drape or softness include, but are not limited to, those described in, U.S. Pat. No. 5,413,811 Fitting et al., U.S. Pat. No. 5,770,531 to Sudduth et al., U.S. Pat. No. 5,810,954 Jacobs et al., U.S. Pat. No. 6,197,404 Varona, U.S. Pat. No. 6,372,172 Sudduth et al. and US2004005457 to DeLucia et al. Examples of softeners include, but are not limited to, the following: olefin waxes such as a polyethylene wax; fatty acids such as erucic, oleic, stearic; fatty acid amides such as stearylamine or oleylamine; sulfated oils such as castor, olive and soybean; sulfated fatty alcohols or fatty acid esters; glycols and derivatives thereof such as glycerin, glyceryl monostearate, glycerol trioleate; polyglycol esters of fatty acids such as palmitic and stearic acids long chain amides; sugar alcohols and derivatives thereof such as sorbitol and sorbitan stearate; imidazolines; and so forth. Examples of additives for improving drape and/or hand-feel of nonwoven webs include, but are not limited to, those described in U.S. Pat. No. 5,770,531 to Sudduth et al., U.S. Pat. No. 6,197,404 Varona, US2004005457 DeLucia et al., and WO2014/044235 to Klaska et al. Increased drape and softness of the nonwoven webs can be achieved by incorporating less than about 5 percent by weight of one or more softening agents in the final composition from which the fibers or nonwoven are extruded or otherwise formed.

The nonwoven web materials incorporated into the elastic laminates of the present disclosure can contain various different polymers. In the past, polymers were selected that do not substantially soften during the melt fusing process so that the webs do not interfere with the formation of the apertures in the elastic film.

Exemplary high-softening point polymers for use in forming nonwoven web materials may include, for instance, polyolefins, e.g., polyethylene, polypropylene, polybutylene, etc.; polytetrafluoroethylene; polyesters, e.g., polyethylene terephthalate and so forth; polyvinyl acetate; polyvinyl chloride acetate; polyvinyl butyral; acrylic resins, e.g., polyacrylate, polymethylacrylate, polymethylmethacrylate, and so forth; polyamides, e.g., nylon; polyvinyl chloride; polyvinylidene chloride; polystyrene; polyvinyl alcohol; polyurethanes; polylactic acid; copolymers thereof; and so forth. If desired, biodegradable polymers, such as those described above, may also be employed. Synthetic or natural cellulosic polymers may also be used, including but not limited to, cellulosic esters; cellulosic ethers; cellulosic nitrates; cellulosic acetates; cellulosic acetate butyrates; ethyl cellulose; regenerated celluloses, such as viscose, rayon, and so forth. It should be noted that the polymer(s) may also contain other additives, such as processing aids or treatment compositions to impart desired properties to the fibers, residual amounts of solvents, pigments or colorants, and so forth.

Monocomponent and/or multicomponent fibers may be used to form the nonwoven web material. Monocomponent fibers are generally formed from a polymer or blend of polymers extruded from a single extruder. Multicomponent fibers are generally formed from two or more polymers (e.g., bicomponent fibers) extruded from separate extruders. The polymers may be arranged in substantially constantly positioned distinct zones across the cross-section of the fibers. The components may be arranged in any desired configuration, such as sheath-core, side-by-side, pie, island-in-the-sea, three island, bull's eye, or various other arrangements and so forth.

As described above, the process of the present disclosure permits the use of low temperature polymers to produce the nonwoven web materials while still providing a process capable of producing laminates having a desired level of air permeability. In this regard, the nonwoven web materials incorporated into the elastic laminate can contain one or more low temperature polymers. The low temperature polymers can have a melting point of less than about 150 °C, such as less than about 140 °C, such as less than about less than about 130 °C, such as less than about 120 °C, such as less than about 110 °C, than about 100 °C, such as less than about 90 °C, such as less than about 80 °C, and generally greater than about 60 °C, such as greater than about 70 °C, such as greater than about 80 °C, such as greater than about 90 °C. The low temperature polymer can have a VICAT softening temperature of less than about 125 °C, such as less than about 120 °C, such as less than about 110 °C, such as less than about 100 °C, such as less than about 90 °C, such as less than about 80 °C, such as less than about 70 °C, such as less than about 60 °C, such as less than about 55 °C, and greater than about 40 °C. Optionally, the low temperature polymer can have a Shore A Hardness of less than about 125, such as less than about 110, such as less than about 100, such as less than about 95, such as less than about 90, and greater than about 50, such as greater than about 65.

The low temperature polymer can be present in the nonwoven web material generally in an amount greater than about 10% by weight, such as in an amount greater than about 20% by weight, such as in an amount greater than about 30% by weight, such as in an amount greater than about 40% by weight, such as in an amount greater than about 50% by weight, such as in an amount greater than about 60% by weight, such as in an amount greater than about 70% by weight, such as in an amount greater than about 80% by weight, such as in an amount greater than about 90% by weight. One or more low temperature polymers can be present in the nonwoven web material generally in an amount less than about 100% by weight, such as in an amount less than about 80% by weight, such as in an amount less than about 60% by weight, such as in an amount less than about 40% by weight, such as in an amount less than about 30% by weight, such as in an amount less than about 20% by weight, such as in an amount less than about 15% by weight, such as in an amount less than about 10% by weight. The low temperature polymer, for instance, may comprise a skin layer on the fibers contained within the nonwoven web material and can be present in relatively low amounts.

In one embodiment, the low temperature polymer can be a non-elastomeric polymer. The non-elastomeric polymer, for instance, can be a polyolefin polymer, such as an ethylene polymer. The ethylene polymer can be an ethylene homopolymer or an ethylene copolymer. In one embodiment, the low temperature polymer can be a low density polyethylene, such as a linear low density polyethylene.

Alternatively, the low temperature polymer can be an elastomeric polymer or have elastic properties. In one aspect, the extensible or elastomeric nonwoven web material can be made from multicomponent fibers containing a low temperature polymer. For example, the multicomponent fibers can be spunbond fibers made from thermoplastic materials with different glass transition or melting temperatures where a first component (e.g., sheath) melts at a temperature lower than a second component (e.g., core). Softening or melting of the first polymer component of the multicomponent fiber allows the multicomponent fibers to form a tacky skeletal structure, which upon cooling, stabilizes the fibrous structure. For example, the multicomponent fibers may have from about 20% to about 80%, and in some embodiments, from about 40% to about 60% by weight of the low melting polymer. Further, the multicomponent fibers may have from about 80% to about 20%, and in some embodiments, from about 60% to about 40%, by weight of the high melting polymer. In some implementations, the core of the sheath-core bicomponent fibers include a polypropylene homopolymer or copolymer based on either Ziegler-Natta catalysts or single site catalysts and/or the sheath of the sheath-core bicomponent fibers include homopolymers, copolymers or mixtures thereof from ethylene, propylene, or styrenic derived polymers.

The bicomponent fiber can contain a polyethylene sheath and a polypropylene based elastomeric core, where the core (but not the sheath) may contain a secondary amide non-blocking additive, which can further improve the garment-like feel of the facing.

For example, in one aspect, the secondary amide additive is erucamide, oleamide, oleyl palmitamide, ethylene bis-oleamide, stearyl erucamide, or combinations thereof. Of course, it should be understood that, in one aspect, the secondary amide may be a non-fatty acid amide.

Regardless of the secondary amide selected, in one aspect, the secondary amide is present in the core in an amount of about 0.1% to about 10% by weight based upon the weight of the core, such as about 0.25% to about 5%, such as about 0.5% to about 2.5%, such as about 0.6% to about 1.5%, such as about 0.7% to about 1%, or any ranges or values therebetween. Particularly, the present disclosure has found that surprisingly, the secondary amide in the core provides improved spinnability and non-blocking properties to the bicomponent fiber, even when used in small amounts in the core.

Moreover, in one aspect, the sheath(s) is/are formed from one or more ethylene or propylene polymers, such as one or more generally non-elastomeric ethylene or propylene polymers. Thus, in one aspect, the non-elastomeric polyolefin may include generally inelastic polymers, such as conventional polyolefins, (e.g., polyethylene), low density polyethylene (LDPE), Ziegler-Natta catalyzed linear low density polyethylene (LLDPE), etc.), ultra low density polyethylene (ULDPE), polypropylene, polybutylene, etc.; polytetrafluoroethylene; polyesters, e.g., polyethylene terephthalate (PET), etc.; polyvinyl acetate; polyvinyl chloride acetate; polyvinyl butyral; acrylic resins, e.g., polyacrylate, polymethylacrylate, polymethylmethacrylate, etc.; polyamides, e.g., nylon; polyvinyl chloride; polyvinylidene chloride; polystyrene; polyvinyl alcohol; polyurethanes; polylactic acid; copolymers and mixtures thereof; and so forth. For instance, the sheath(s) can include an LLDPE available from Dow Chemical Co. of Midland, Mich., such as DOWLEX™ 2517 or DOWLEX™ 2047, or a combination thereof, or Westlake Chemical Corp. of Houston, Tex. Furthermore, in one aspect, the non-blocking polyolefin material may be other suitable ethylene polymers, such as those available from The Dow Chemical Company under the designations ASPUN™ (LLDPE) and ATTANE™ (ULDPE). available from The Dow Chemical Company under the designations DOWLEX™ (LLDPE), ASPUN™ (LLDPE), and ATTANE™ (ULDPE).

Further, in an aspect, the core is formed from a propylene polymer and/or copolymer. Thus, in one aspect, the core is formed from a propylene-based copolymer plastomers, such as a propylene-based copolymer commercially available under the designations VISTAMAXX™ (e.g., 2330, 6202, and 6102), a propylene-ethylene copolymer-based plastomer from ExxonMobil Chemical Co. of Houston, Texas; FINA™ (e.g., 8573) from Atofina Chemicals of Feluy, Belgium; TAFMER™ available from Mitsui Petrochemical Industries; and VERSIFY™ available from Dow Chemical Co. of Midland, Michigan. In addition to the above, the core can also contain a non-elastomeric olefin polymer, such as a metallocene catalyzed (single site catalyzed) polypropylene polymer in an amount of from about 1% by weight to about 40% by weight of the core, such as from about 2% by weight to about 5% by weight of the core.

Regardless of the elastomer(s) and non-elastomeric polyolefin selected, in one aspect the core is present in an amount of about 50% to about 97.5% by weight of the total weight of the elastomeric composition, such as about 60% to about 95%, such as about 70% to about 92.5%, such as about 80% to about 90%, such as about 82.5% to about 87.5% by weight of the total weight of the elastomeric composition, or any ranges or values therebetween.

The elastic laminates of the present disclosure may be readily incorporated into an end product as is known in the art. One skilled in the art will appreciate that the elastic laminates of the present disclosure can be used in absorbent personal care articles including, for example, diapers, adult incontinence garments, incontinence pads/liners, sanitary napkins, panty-liners and so forth. In this regard, absorbent personal care articles commonly include a liquid-impervious outer cover, a liquid permeable topsheet positioned in facing relation to the outer cover, and an absorbent core between the outer cover and topsheet. Further, absorbent personal care articles also commonly include one or more fit related components such as fastening tapes or tabs, waistbands, elastic waist panels, elastic side panels, elasticated leg cuffs, and so forth. The unique elastic laminates made and provided herein are well suited for use as or as a component of absorbent personal care articles having one or more elasticated components. By way of example only, various personal care absorbent articles including elastic components and methods of making the same are described in U.S. Pat. No. 4,685,916 to Enloe, U.S. Pat. No. 4,816,094 Pomplum et al., U.S. Pat. No. 4,857,067 to Wood et al., U.S. Pat. No. 6,336,922 VanGompel et al., U.S. Pat. No. 6,953,452 Popp et al., U.S. Pat. No. 7,018,369 VanGompel et al., U.S. Pat. No. 7,150,731 Cazzato et al., the contents of which are incorporated herein by reference to the extent consistent herewith.

As previously noted, absorbent personal care articles generally include a liquid permeable topsheet, which faces the wearer, and a liquid-impermeable backsheet or outer cover. Disposed between the topsheet and outer cover is an absorbent core. In this regard, the topsheet and outer cover are often joined and/or sealed to encase the absorbent core. Although certain aspects of the present invention are described in the context of a particular personal care absorbent article, it will be readily appreciated that similar uses in other types of personal care absorbent articles and/or further combinations or alterations of the specific configurations discussed below may be made by one skilled in the art without departing from the spirit and scope of the present invention.

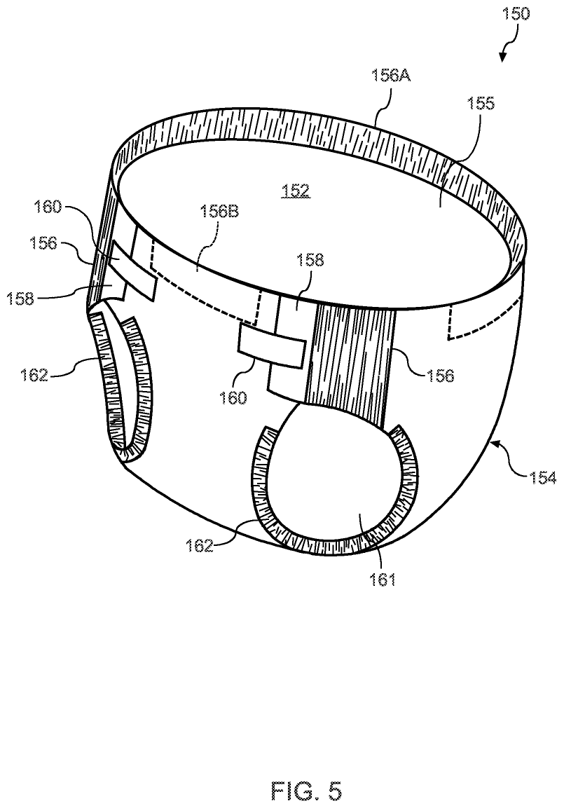

In a particular embodiment, and in reference to FIG. 5, a diaper 150 can comprise a liquid-impervious outer cover 154, a liquid permeable topsheet 152 positioned in facing relation to the outer cover 154, and an absorbent core (not shown) between the outer cover 154 and topsheet 152. The diaper 150 may be of various shapes such as, for example, an overall rectangular shape, T-shape, hourglass shape and so forth. The topsheet is generally coextensive with the outer cover but may optionally cover an area that is larger or smaller than the area of the outer cover, as desired. While not shown, it is to be understood that portions of the diaper, such as a marginal section of the outer cover, may extend past and around the terminal edges of the product and form a portion of the body-facing layer.

The topsheet or body-side liner 152 desirably presents a body facing surface which is compliant, soft to the touch, and non-irritating to the wearer's skin. The topsheet 152 is desirably employed to help isolate the wearer's skin from liquids held in the absorbent core. Topsheets are well known in the art and may comprise a wide variety of materials, such as porous foams, reticulated foams, apertured plastic films, natural fibers (wool, cotton fibers, etc.), synthetic fibers (polyester, polypropylene, polyethylene, etc.), combinations of natural and synthetic fibers, and so forth. Topsheets can comprise a single layer or a multiple layers including a combination of one or more different materials. Apertured films, nonwoven fabrics, and laminates thereof, are commonly utilized to form topsheets.

Suitable topsheet materials include, but not limited to, those described in U.S. Pat. No. 5,382,400 to Pike et al., U.S. Pat. No. 5,415,640 to Kirby et al., U.S. Pat. No. 5,527,300 to Sauer, U.S. Pat. No. 5,994,615 to Dodge et al., U.S. Pat. No. 6,383,960 to Everett et al., U.S. Pat. No. 6,410,823 to Daley et al., and US2014/0121623 to Biggs et al.

The backsheet or outer cover 154 comprises a liquid-impervious material. Desirably, the outer cover comprises a material that prevents the passage of water but allows air and water-vapor to pass there through. The outer cover can comprise a single layer of material or multiple layers including one or more layers of different materials. In a particular embodiment, the outer cover can comprise a film fixedly attached or bonded to one or more nonwoven webs. The particular structure and composition of the outer cover may be selected from various combinations of films and/or fabrics. In this regard, the outer most layers are generally selected to provide the desired strength, abrasion resistance, tactile properties and/or aesthetics. Suitable outer covers include, but are not limited to, those described in U.S. Pat. No. 4,041,203 to Brock et al., U.S. Pat. No. 6,075,179 et al. to McCormack et al., U.S. Pat. No. 6,111,163 to McCormack s et al., and US2015/099086 to Cho et al., the contents of which are incorporated herein to the extent consistent herewith.

In the present embodiment, the diaper 150 may include an elastic waistband 156 located about the waist opening 155. The elastic composite providing the elasticity for the waistband can be located either exposed on the skin-contacting side of the topsheet, exposed on the outside of the backsheet and/or positioned between the topsheet and backsheet. When positioned on the skin-contacting surface of the topsheet, the waistband can also provide a dual function of acting as a containment pocket as is known in the art. Further, in certain embodiments the diaper may be provided with separate front and rear waistbands respectively 156A, 156B. Alternatively, for certain pant style garments, a continuous elastic waistband may be employed.

The diaper 150 may, in certain embodiments, further include elastic side panels 157. The elastic laminate providing the elasticity to the side panels can form all or a portion of each side panel. For example, optionally, an inelastic panel 158 may be positioned between the fastener 160 and the elastic laminate forming a portion of the side panel 156. As is known in the art, the elastic side panels may be integrally formed with the backsheet and/or topsheet or, alternatively, comprise a separate component that is attached to the central diaper chassis such as being attached to one or more of the backsheet and/or topsheet.

The diaper 150 may further include elastic leg cuffs 162 located about the leg openings 161. The leg cuffs may be curved about the leg opening or multiple leg elastics may be used extending proximate the leg openings towards the side panels and front and rear waist openings.

The personal care articles can, optionally, contain one or more additional elements or components. In this regard, numerous additional features and various constructions are known in the art. One skilled in the art will appreciate the application and use of the elastic composite of the present invention may be used as or in one or more components to provide the desired elasticity and hand-feel. In addition, one skilled in the art will appreciate that the elastic laminate may similarly be used to provide elasticity and/or fit enhancing attributes to other garments or articles including for example protection garments. In this regard, the elastic composite can be employed to form elastic panels, waistbands, cuffs, fastening tabs and so forth. By way of example only, the elastic composite may be employed in the garments as described in U.S. Pat. No. 5,594,955 Sommers, U.S. Pat. No. 6,799,331 Griesbach et al., and US2005/097659 to Aroch et al., the contents of which are incorporated herein by reference to the extent consistent herewith. In a similar manner, the elastic composite may be employed in still other articles such as sweat pads, bandages, body-wraps, and protection articles.

In a further aspect, the elastic composite laminate of the present invention may be used as a wiper suitable for personal use or use on hard surfaces. The selection of the individual layers will of course vary with respect to the intended end use. For example, for use as a personal care wipe, typically the materials selected will have a greater emphasis on softness and hand-feel whereas those intended for hard surface cleaning may have a greater emphasis on strength and durability. The laminates of the present invention may be used for the formation of wipes, stacks of wipes and other products including, but not limited to, those described in U.S. Pat. No. 3,401,927 to Frick et al.; U.S. Pat. No. 4,171,047 to Doyle et al., U.S. Pat. No. 4,502,675 to Clark et al.; U.S. Pat. No. 4,353,480 to McFadyen, U.S. Pat. No. 4,651,895 Niske et al., U.S. Pat. No. 4,741,944 to Jackson et al., U.S. Pat. No. 4,778,048 to Kaspar et al., U.S. Pat. No. 5,264,265 to Kaufmann, U.S. Pat. No. 5,310,398 to Yoneyama, U.S. Pat. No. 5,964,351 Zander, U.S. Pat. No. 6,158,614 to Haines et al., U.S. Pat. No. 6,592,004 to Huang et al. and U.S. Pat. No. 6,612,462 to Sosalla et al.

### Test Methods

Tensile Strength: As used herein “tensile strength” or “strip tensile”, is the peak load value, i.e. the maximum force produced by a specimen, when it is pulled to rupture. Samples for tensile strength testing are prepared by die cutting test specimens to a width of 25 mm and length of approximately 152 mm. The instrument used for measuring tensile strengths is an MTS Criterian 42 and MTS TestWorks™ for Windows Ver. 4 (MTS Systems Corp., Research Triangle Park, NC). The load cell is selected, depending on the strength of the sample being tested, such that the peak load values fall between 10 and 90 percent of the load cell's full scale load. The gauge length is 76 mm and jaw length is 76 mm. The crosshead speed is 305 mm/minute, and the break sensitivity is set at 70% and the slope preset points at 70 and 157 g. The sample is placed in the jaws of the instrument and centered with the longer dimension parallel to the direction of the load application. The test is then started and ends when the specimen breaks. The peak load is determined, for purposes herein, based upon the CD tensile strength. Six (6) representative specimens are tested, and the arithmetic average of all individual specimen tested is the tensile strength for the product.

Extension at 2000 gf: This value is the percent extension of the elastic laminate in the machined direction with a stretching force of 2000 gf applied thereto. Samples for tensile strength testing are prepared by die cutting test specimens to a CD length of 25 mm and an MD length of approximately 152 mm. The instrument used for measuring tensile strengths is an MTS Criterian 42 and MTS TestWorks™ for Windows Ver. 4 (MTS Systems Corp., Research Triangle Park, NC). The load cell is selected, depending on the strength of the sample being tested, such that the peak load values fall between 10 and 90 percent of the load cell's full scale load. The gauge length is 50 mm and the rubber faced grips are 25×10² mm. The crosshead speed is 500 mm/minute. The sample is placed in the jaws of the instrument and centered with the longer dimension parallel to the direction of the load application. The test is then started and is initially elongated to stop, returning the sample to the initial gauge length and then pulling the sample to break. Stress/strain data indicate the force required to elongate the specimen. The load at elongation output characterizes the force at the specified point of specimen elongation. The higher the force value, the more difficult it is to elongate the specimen. The determination of the load at the desired elongation is taken from the second cycle. Six (6) representative specimens are tested, and the arithmetic average of all individual specimen tested is the tensile strength for the product.

As used herein “basis weight” is determined using the average dry weight of twelve (12) 150 mm×150 mm specimens.

As used herein “caliper” or “thickness” of a sheet is determined by using a micrometer having an acrylic platen with a pressure foot area of 45.6 cm² (3 inch diameter), providing a load of 0.345 kPa (0.5 psi), and the reading is taken after a dwell time of 3 seconds. A sample is cut having a size of 90×10² mm (3.5×4 inches) is used for the measurement.

As used herein air permeability is conducted on dry samples and determined using a TEXTEST FX 3300 Air Permeability Tester from Textest AG using a test pressure of 125 Pa and a test head area of 38 cm².

### Example No. 1

Various different elastic laminates were produced that contained an elastic film positioned in between two layers of nonwoven web materials. The process used to produce the laminates is similar to the process illustrated in FIG. 1. Three different elastic laminates were produced. For each elastic laminate, the nip speed of the tension device (e.g., 32) downstream from the perforating and bonding device (e.g., 26) was varied such that the elastic laminate was able to retract a different amount during each trial.

The elastic film for each elastic laminate was the same. The elastic film for each sample was comprised of a 100% semi-crystalline olefinic elastic copolymer.

The elastic laminate was made using a cast film based process described in U.S. Pat. No. 7,803,244B2 and U.S. Pat. No. 8,361,913B2 with the outer facing layers being simultaneously unwound from winding rolls and directed into the nip of the laminating rollers so as to lay adjacent opposite sides of the elastic film forming a nonwoven/film/nonwoven stack. The nonwoven facings were unwound and directed into the nip of the laminating rolls at substantially the same speed as the laminating rolls. The elastic film was stretched in the machine-direction and melt fused to the nonwoven layers to form a cohesive laminate as a result of passing through the nip of the laminating roll assembly (patterned roll opposite an anvil roll). After the laminating roll assembly, the laminate was fed into a nip of a tension device. After the tension device, the laminate was allowed to retract and wound onto a winder roll.

The outer nonwoven layers used during the trials were as follows:
Sample No. 1: both layers were a 15 gsm polypropylene spunbond facing.
Sample No. 2: one layer was a 15 gsm polypropylene spunbond facing and one layer was a 17 gsm bicomponent spunbond composed of at least one low temperature polymer, e.g. a polyethylene and a semi-crystalline polypropylene elastomer.
Sample No. 3: both layers were a 17 gsm bicomponent spunbond composed of polyethylene and a semi-crystalline polypropylene elastomer (contained low temperature polymer).

After the elastic laminates were formed, the laminates were tested for air permeability on the same day the laminates were formed and then were tested again for permeability three weeks after the laminates were formed. The following results were obtained:

| | Tension Device Nip | | |
|---|---|---|---|
| | Speed (as % of | Avg Air | Avg Aged Air |
| Sample | Laminating | Permeability | Permeability |
| No. | Roll Speed) | (cfm) | (cfm) |
| 1 | 43 | 36 | 34 |
| | | (42 40 | (33.1 33.5 |
| | | 33 30 35) | 34.8 36.2 32.4) |
| | 53 | 52 | 47 |
| | | (54 53 | (49.8 44.4 |
| | | 53 49 51) | 46.6 46.5 47) |
| 2 | 38 | 43 | 25 |
| | | (35 34 | (17.8 17.5 |
| | | 59 46 39) | 28 30.6 30.8) |
| | 53 | N/A | 89 |
| | | | (92.6 80.8 |
| | | | 105 91.3 73.7) |
| 3 | 38 | 66 | N/A |
| | | (60 63 | |
| | | 76 96 35) | |
| | 53 | 88 | N/A |
| | | (85 91 | |
| | | 101 102 59) | |

As shown above, the air permeability of the laminate was a function of the amount the laminate was able to retract after exiting the laminating rolls. Maintaining greater tension on the laminate increased the air permeability.

### Example No. 2

Further elastic laminates were produced that contained an elastic film and at least one layer of a nonwoven web material. Samples 4 and 5 were produced on a pilot line while Sample 6 was produced on a commercial line.

The elastic film for each sample was comprised of 100% semi-crystalline olefinic elastic copolymers. The elastic laminate was made using a cast film based process described in U.S. Pat. No. 7,803,244B2 and U.S. Pat. No. 8,361,913B2 with the outer facing layers being simultaneously unwound from winding rolls and directed into the nip of the laminating rollers so as to lay adjacent opposite sides of the elastic film forming a nonwoven/film/nonwoven stack. The nonwoven facings were unwound and directed into the nip of the laminating rolls at substantially the same speed as the laminating rolls. The elastic film was stretched in the machine-direction and melt fused to the nonwoven layers to form a cohesive laminate as a result of passing through the nip of the laminating roll assembly. After the laminating roll assembly, the laminate was fed into a nip of a tension device. After the tension device, the laminate was allowed to retract and wound onto a winder roll.

The outer nonwoven layers used during the trials were as follows. Both samples contained a low temperature polymer.

Sample No. 4: both layers were a 17 gsm bicomponent spunbond composed of polyethylene and a semi-crystalline polypropylene elastomer.

Sample No. 5: one layer was an 11 gsm polypropylene spunbond facing and one layer was a 17 gsm bicomponent spunbond composed of polyethylene and a semi-crystalline polypropylene elastomer.

After the elastic laminates were formed, the laminates were tested for air permeability on the same day the laminates were formed and then were tested again for permeability approximately one week after the laminates were formed. The following results were obtained:

| | Tension Device Nip | | |
|---|---|---|---|
| | Speed (as % of | Avg Air | Avg Aged Air |
| Sample | Laminating | Permeability | Permeability |
| No. | Roll Speed) | (cfm) | (cfm) |
| 4 | 44 | 2 | 2 |
| | 100 | 45 | 32 |
| 5 | 44 | 12 | 12 |
| | 100 | 153 | 149 |

In the following trial, the elastic laminate was made using a cast film-based process described in U.S. Pat. No. 7,803,244B2 and U.S. Pat. No. 8,361,913B2 with a single 12 gsm polypropylene spunbond outer facing layer being simultaneously unwound from winding rolls and directed into the nip of the laminating rollers so as to lay adjacent to the elastic film forming a nonwoven/film stack. Additionally, coextruded with the elastic film was a film skin layer coextruded on the side opposite the nonwoven layer. The overall film weight was comprised of 5% by weight skin layer. The skin layer containing a low temperature polymer was composed of 50% LLDP and 50% polyethylene-based plastomer while the elastic film for each sample was composed of 100% semi-crystalline olefinic elastic copolymers.

The coextruded film and the nonwoven facing were unwound and directed into the nip of the laminating rolls at substantially the same speed as the laminating rolls. The elastic film was stretched in the machine-direction and melt fused to the nonwoven layer to form a cohesive laminate as a result of passing through the nip of the laminating roll assembly heated to at least 150C on the nonwoven side and at least 101C on the film side. After the laminating roll assembly, the laminate was fed into a nip of a tension device. After the tension device, the laminate was allowed to retract and wound onto a winder roll.

| | Tension Device Nip | |
|---|---|---|
| | Speed (as % of | Avg Air |
| Sample | Laminating | Permeability |
| No. | Roll Speed) | (cfm) |
| 6 | 32 | Cannot make due |
| | | to sheet sticking |
| | | on hot |
| | | laminating rolls |
| | 47 | 35 |
| | | (34 32 33 27 |
| | | 36 47 46 23) |
| | 61 | 62 |
| | | (63 70 72 72 |
| | | 46 86 61 68 |
| | | 75 70 66 53 |
| | | 36 63 30 73 |
| | | 73 31 78 61 |
| | | 63 69 36 79 |
| | | 72 57 66 75 |
| | | 30 67 42 78) |

These and other modifications and variations to the present invention may be practiced by those of ordinary skill in the art, without departing from the spirit and scope of the present invention, which is more particularly set forth in the appended claims. In addition, it should be understood that aspects of the various embodiments may be interchanged both in whole or in part. Furthermore, those of ordinary skill in the art will appreciate that the foregoing description is by way of example only and is not intended to limit the invention so further described in such appended claims.

1. A method of forming a nonwoven composite, the method comprising:
concurrently melt fusing and perforating an elastic film to a nonwoven web material and forming apertures in the film while the film is under tension at a stretch ratio of about 1.5 or more in a machine direction; and
maintaining the film under tension such that the film retracts by no more than about 55% in the machine direction after the apertures have formed and the film has been melt fused to the nonwoven web material.

2. The method of claim 1, wherein the nonwoven composite is thereafter retracted such that less than 20% of stretch in remains in the film in the machine direction prior to or during winding onto a roll.

3. The method of claim 1, wherein the film is maintained under tension such that the film retracts by no more than about 50%, in the machine direction after the apertures have formed and the film has been melt fused to the nonwoven web material.

4. The method of claim 1, wherein at least one of the apertures has a length of from about 200 to about 5000 micrometers.

5. The method of claim 1, wherein the nonwoven composite has a permeability of greater than about 10 cfm.

6. The method of claim 1, wherein the film is maintained under tension after the apertures have formed and the film has been melt fused to the nonwoven web material for at least about 0.1 seconds and for less than about 10 seconds.

7. The method of claim 1, wherein the film is maintained under tension after the apertures have formed and the film has been melt fused to the nonwoven web material by a downstream tension device.

8. The method of claim 7, wherein the tension device comprises a nip formed between two rolls or comprises an s-wrap configuration of guide rolls.

9. The method of claim 1, wherein the nonwoven web material and the elastic film are melt fused at a plurality of discrete bond sites separated by unbonded areas.

10. The method of claim 1, wherein the elastic film comprises an elastomeric block copolymer or an elastomeric semi-crystalline polyolefin, and wherein the semi-crystalline polyolefin is an ethylene/α-olefin copolymer, propylene/α-olefin copolymer, or a combination thereof.

11. The method of claim 1, wherein the elastic film is apertured and melt fused under tension at a stretch ratio of from about 2.5 to about 7.0.

12. The method of claim 1, wherein the nonwoven web material contains fibers comprising spunbond fibers, meltblown fibers, staple fibers, or a combination thereof and wherein the fibers comprise a low temperature polymer.

13. The method of claim 12, wherein the low temperature polymer comprises a polyethylene polymer, a poly(lactic acid), a polyhydroxyalkanoate polymer, a poly(ethylene adipate) polymer, a poly(ethylene oxide) (PEG) polymer, an elastomer, a plastomer, a random copolymer, or a polymer blend containing a plasticizer.

14. The method of claim 12, wherein the low temperature polymer has a melting point of less than about 150 °C.

15. The method of claim 12, wherein the low temperature polymer has a VICAT softening temperature of less than about 125 °C and greater than about 40 °C.

16. The method of claim 12, wherein the low temperature polymer has a Shore A Hardness of less than about 110 and greater than about 65.

17. The method of claim 1, wherein the elastic film is concurrently melt fused and perforated to the nonwoven web material by being fed through a nip formed between two rolls and wherein at least one of the rolls is heated to a surface temperature of from about 50 °C to about 160 °C.

18. The method of claim 1, wherein the nonwoven web material is unapertured after being melt fused to the film.

19. The method of claim 1, wherein an additional nonwoven web material is melt fused to the elastic film such that the elastic film is positioned between the nonwoven web materials.

20. The method of claim 1, wherein the elastic film includes a skin layer and wherein the skin layer is positioned on the elastic film opposite the nonwoven web material, the skin layer comprising a low temperature polymer.

21. A nonwoven composite comprising:
an elastic film that contains an elastomeric polymer;
and a nonwoven web material that contains fibers and wherein the fibers comprise a low temperature polymer, wherein the film is positioned adjacent and melt fused to the nonwoven web material so that the elastic film adheres to the nonwoven web material at a plurality of discrete bond sites, the elastic film defining a plurality of apertures having a perimeter about which the corresponding discrete bond sites are proximately located, wherein at least one of the apertures has a length of from about 200 to about 5000 micrometers, wherein the nonwoven web material is unapertured at an area adjacent to the aperture in the film and is unbonded to the film except at the corresponding discrete bond sites, the nonwoven composite having a permeability of greater than about 10 cfm.

22.-28. (canceled)

29. A nonwoven composite comprising:
an elastic film that contains an elastomeric polymer and at least one skin layer, the skin layer comprising a low temperature polymer; and
a nonwoven web material that contains fibers, wherein the film is positioned adjacent and melt fused to the nonwoven web material along a surface opposite the skin layer so that the elastic film adheres to the nonwoven web material at a plurality of discrete bond sites, the elastic film defining a plurality of apertures having a perimeter about which the corresponding discrete bond sites are proximately located, wherein at least one of the apertures has a length of from about 200 to about 5000 micrometers, wherein the nonwoven web material is unapertured at an area adjacent to the aperture in the film and is unbonded to the film except at the corresponding discrete bond sites, the nonwoven composite having a permeability of greater than about 25 cfm, such as less than about 40 cfm.

30.-37. (canceled)
